(19) United States
(12) Patent Application Publication
(10) Pub. No.: US 2026/0279402 A1
(43) Pub. Date: Sep. 17, 2026

(54) METHOD FOR CONTINUING VIDEO RECORDING AND RECORDING DEVICE

(71) Applicant: ARASHI VISION INC., Shenzhen (CN)

(72) Inventors: Tuzhong LONG, Shenzhen (CN); Genyuan WANG, Shenzhen (CN); Yanbing DENG, Shenzhen (CN)

(73) Assignee: ARASHI VISION INC., Shenzhen (CN)

(21) Appl. No.: 19/678,164

(22) Filed: May 15, 2026

Related U.S. Application Data
(63) Continuation of application No. PCT/CN2023/132386, filed on Nov. 17, 2023.

(51) Int. Cl. G11B 27/036; G11B 27/06; G11B 27/10; H04N 5/77

(52) U.S. Cl. CPC G11B 27/036; G11B 27/06; G11B 27/10; H04N 5/772

(57) ABSTRACT

A method for continuing video recording applied to a recording device including an interactive device includes obtaining a video to be processed. The video to be processed includes a recorded video or a paused video that the recording device has currently paused recording during a recording process. The method further includes in response to a user operation of the interactive device, controlling the recording device to record a continuation video; in response to determining that the video to be processed is the recorded video, generating a target video according to the recorded video and the continuation video; and in response to determining that the video to be processed is the paused video that the recording device has currently paused recording, generating a target video according to the paused video and the continuation video.

### CROSS-REFERENCE TO RELATED APPLICATION

This application is a continuation of International Application No. PCT/CN2023/132386, filed on November 17, 2023, the entire content of which is hereby incorporated by reference in its entirety.

### BACKGROUND

The present disclosure relates to the field of video technology, particularly to a method for continuing video recording and a recording device.

With the development of the video field, continuation technology has emerged, which involves splicing multiple short videos shot at different times into a complete video, allowing viewers to see the entire event process through the complete video.

In related technology, taking a sports camera as an example, to achieve the continuation function of the sports camera, users need to record multiple short videos through multiple recordings in the early stage and then use professional editing software to edit these short videos in the later stage to obtain a complete video.

However, the complete video obtained through the above technology has the problem of poor picture continuity.

### SUMMARY

Based on this, it is necessary to address the above technical problem by providing a method for continuing video recording and a recording device that can reduce the complexity of video continuation.

In the first aspect, the present disclosure provides a method for continuing video recording, which is applied to a recording device. The recording device includes an interactive device, and the method includes:

obtaining a video to be processed, where the video to be processed includes a recorded video or a paused video that the recording device has currently paused recording, and the recording device is configured to pause recording during a recording process;

in response to a user operation of the interactive device, controlling the recording device to record a continuation video; and

when the video to be processed is the recorded video, generating a target video according to the recorded video and the continuation video; or

when the video to be processed is the paused video that the recording device has currently paused recording, generating a target video according to the paused video and the continuation video.

In one embodiment, obtaining the recorded video includes:

displaying at least one pre-stored video on an album page of the recording device;

in response to the user operation of the interactive device, determining a candidate video selected by the user from the at least one pre-stored video; and

determining the candidate video as the recorded video.

In one embodiment, in response to the user operation of the interactive device, determining the candidate video selected by the user from the at least one pre-stored video includes:

obtaining a reference video selected by the user from the pre-stored video;

based on the user operation of the interactive device, obtaining a to-be-cut segment selected by the user from the reference video; and

deleting the to-be-cut segment from the reference video to obtain a trimmed video, and determining the candidate video according to the trimmed video.

In one embodiment, based on the user operation of the interactive device, obtaining the to-be-cut segment selected by the user from the reference video includes:

in a case where the user performs a trim activation operation on the interactive device, displaying a display element corresponding to the reference video; and

based on a segment selection operation of the user on the display element, determining the to-be-cut segment.

In one embodiment, deleting the to-be-cut segment from the reference video to obtain the trimmed video includes:

obtaining a first video segment before the start time from the reference video according to the start time of the to-be-cut segment;

obtaining a second video segment after the end time from the reference video according to the end time of the to-be-cut segment; and

splicing the first video segment and the second video segment to obtain the trimmed video.

In one embodiment, obtaining the paused video that the recording device has currently paused recording includes:

when the recording device is in a recording state, obtaining a user operation of the interactive device; and

based on the user operation of the interactive device, determining the paused video that the recording device has currently paused recording.

In one embodiment, based on the user operation of the interactive device, determining the paused video that the recording device has currently paused recording includes:

in a case where the user performs a first operation on a recording element of the interactive device, controlling the recording device to pause recording to obtain a paused segment; and

determining the paused video that the recording device has currently paused recording according to the paused segment.

In one embodiment, determining the paused video that the recording device has currently paused recording according to the paused segment includes:

based on a second operation of the user on the interactive device, obtaining a to-be-cut segment selected by the user from the paused segment;

deleting the to-be-cut segment from the paused segment to obtain a trimmed video; and

determining the paused video that the recording device has currently paused recording according to the trimmed video.

In one embodiment, based on the second operation of the user on the interactive device, obtaining the to-be-cut segment selected by the user from the paused segment includes:

in a case where the user performs a trim activation operation on the interactive device, displaying a display element corresponding to the paused segment; and

based on a segment selection operation of the user on the display element, determining the to-be-cut segment.

In one embodiment, deleting the to-be-cut segment from the paused segment to obtain the trimmed video includes:

obtaining a third video segment before the start time from the paused segment according to the start time of the to-be-cut segment;

obtaining a fourth video segment after the end time from the paused segment according to the end time of the to-be-cut segment; and

splicing the third video segment and the fourth video segment to obtain the trimmed video.

In one embodiment, in response to a user operation of the interactive device, controlling the recording device to record a continuation video includes:

in response to the user operation of the interactive device, obtaining a recording parameter based on at least one video parameter of the video to be processed; and

controlling the recording device to record a video according to the recording parameter to obtain the continuation video.

In one embodiment, obtaining the recording parameter based on the at least one video parameter of the video to be processed includes:

obtaining a video file of the video to be processed, the video file includes file information of the video to be processed;

parsing the file information according to a preset file parsing method to obtain at least one video parameter of the video to be processed; and

determining the recording parameter according to the at least one video parameter.

In one embodiment, controlling the recording device to record a video according to the recording parameter to obtain the continuation video includes:

detecting whether a condition for stopping recording is met; and

if the condition for stopping recording is met, controlling the recording device to stop recording to obtain the continuation video.

In one embodiment, the condition for stopping recording includes at least one of the following:

receiving a stop recording instruction input by a user;

a duration of the current continuation recording reaches a preset recording duration; or

a current memory space reaches a preset memory space occupation threshold.

In one embodiment, generating the target video according to the recorded video and the continuation video includes:

in response to a user operation of the interactive device, confirming an insertion position of the continuation video in the recorded video; and

inserting the continuation video into the insertion position.

In one embodiment, before inserting the continuation video into the insertion position, the method further includes:

deleting a target segment after the insertion position in the recorded video.

In one embodiment, generating the target video according to the recorded video and the continuation video includes:

splicing the recorded video and the continuation video to generate the target video.

In one embodiment, splicing the recorded video and the continuation video to generate the target video includes:

determining a first splicing position of the recorded video;

determining a second splicing position of the continuation video; and

splicing the second splicing position of the continuation video with the first splicing position of the recorded video, until the recording of the continuation video ends, to obtain the target video.

In one embodiment, determining the first splicing position of the recorded video includes:

verifying each frame of the recorded video; and

determining the first splicing position based on a verification result of each frame of the recorded video.

In one embodiment, generating the target video according to the paused video and the continuation video includes:

in response to a user operation of the interactive device, confirming an insertion position of the continuation video in the paused video; and

inserting the continuation video into the insertion position.

In one embodiment, before inserting the continuation video into the insertion position, the method further includes:

deleting a target segment after the insertion position in the paused video.

In one embodiment, generating the target video according to the paused video and the continuation video includes:

splicing the paused video and the continuation video to generate the target video.

In one embodiment, splicing the paused video and the continuation video to generate the target video includes:

determining a third splicing position of the paused video;

determining a fourth splicing position of the continuation video; and

splicing the fourth splicing position of the continuation video with the third splicing position of the paused video, until the recording of the continuation video ends, to obtain the target video.

In one embodiment, determining the third splicing position of the paused video includes:

verifying each frame of the paused video; and

determining the third splicing position based on a verification result of each frame of the paused video.

In the second aspect, the present disclosure also provides a recording device, including: a camera, a display, a processor, a memory, and an interactive device, where the camera is used for capturing images; the display is connected to the processor; the memory stores a computer program including instructions; and when the instructions are executed by the processor, the processor is configured to:

obtain a video to be processed, the video to be processed includes a recorded video or a paused video that the camera of the recording device has currently paused recording, where the recording device is configured to pause recording during a recording process;

in response to a user operation of the interactive device, control the camera of the recording device to record a continuation video; and

when the video to be processed is the recorded video, generate a target video according to the recorded video and the continuation video; or

when the video to be processed is the paused video that the recording device has currently paused recording, generate a target video according to the paused video and the continuation video.

In one embodiment, the processor is further configured to:

control the display to display at least one pre-stored video on an album page of the recording device;

in response to the user operation of the interactive device, determine a candidate video selected by the user from the at least one pre-stored video; and

determine the candidate video as the recorded video.

In one embodiment, the processor is further configured to:

obtain a reference video selected by the user from the pre-stored video;

based on the user operation of the interactive device, obtain a to-be-cut segment selected by the user from the reference video; and

delete the to-be-cut segment from the reference video to obtain a trimmed video, and determine the candidate video according to the trimmed video.

In one embodiment, the processor is further configured to:

in a case where the user performs a trim activation operation on the interactive device, control the display to display a display element corresponding to the reference video; and

based on a segment selection operation of the user on the display element, determine the to-be-cut segment.

In one embodiment, the processor is further configured to:

obtain a first video segment before the start time from the reference video according to the start time of the to-be-cut segment;

obtain a second video segment after the end time from the reference video according to the end time of the to-be-cut segment; and

splice the first video segment and the second video segment to obtain the trimmed video.

In one embodiment, the processor is further configured to:

when the camera of the recording device is in a recording state, obtain a user operation of the interactive device; and

based on the user operation of the interactive device, determine the paused video that the recording device has currently paused recording.

In one embodiment, the processor is further configured to:

in a case where the user performs a first operation on a recording element of the interactive device, control the camera of the recording device to pause recording to obtain a paused segment; and

determine the paused video that the recording device has currently paused recording according to the paused segment.

In one embodiment, the processor is further configured to:

based on a second operation of the user on the interactive device, obtain a to-be-cut segment selected by the user from the paused segment;

delete the to-be-cut segment from the paused segment to obtain a trimmed video; and

determine the paused video that the recording device has currently paused recording according to the trimmed video.

In one embodiment, the processor is further configured to:

in a case where the user performs a trim activation operation on the interactive device, control the display to display a display element corresponding to the paused segment; and

based on a segment selection operation of the user on the display element, determine the to-be-cut segment.

In one embodiment, the processor is further configured to:

obtain a third video segment before the start time from the paused segment according to the start time of the to-be-cut segment;

obtain a fourth video segment after the end time from the paused segment according to the end time of the to-be-cut segment; and

splice the third video segment and the fourth video segment to obtain the trimmed video.

In one embodiment, the processor is further configured to:

in response to the user operation of the interactive device, obtain a recording parameter based on at least one video parameter of the video to be processed; and

control the camera of the recording device to record a video according to the recording parameter to obtain the continuation video.

In one embodiment, the processor is further configured to:

obtain a video file of the video to be processed, the video file includes file information of the video to be processed;

parse the file information according to a preset file parsing method to obtain at least one video parameter of the video to be processed; and

determine the recording parameter according to the at least one video parameter.

In one embodiment, the processor is further configured to:

detect whether a condition for stopping recording is met; and

if the condition for stopping recording is met, controlling the camera of the recording device to stop recording to obtain the continuation video.

In one embodiment, the condition for stopping recording includes at least one of the following:

receiving a stop recording instruction input by a user;

a duration of the current continuation recording reaches a preset recording duration; or

a current memory space reaches a preset memory space occupation threshold.

In one embodiment, the processor is further configured to:

in response to a user operation of the interactive device, confirm an insertion position of the continuation video in the recorded video; and

insert the continuation video into the insertion position.

In one embodiment, the processor is further configured to:

delete a target segment after the insertion position in the recorded video.

In one embodiment, the processor is further configured to:

splice the recorded video and the continuation video to generate the target video.

In one embodiment, the processor is further configured to:

determine a first splicing position of the recorded video;

determine a second splicing position of the continuation video; and

splice the second splicing position of the continuation video with the first splicing position of the recorded video, until the recording of the continuation video ends, to obtain the target video.

In one embodiment, the processor is further configured to:

verify each frame of the recorded video; and

determine the first splicing position based on a verification result of each frame of the recorded video.

In one embodiment, the processor is further configured to:

in response to a user operation of the interactive device, confirm an insertion position of the continuation video in the paused video; and

insert the continuation video into the insertion position.

In one embodiment, the processor is further configured to:

delete a target segment after the insertion position in the paused video.

In one embodiment, the processor is further configured to:

splice the paused video and the continuation video to generate the target video.

In one embodiment, the processor is further configured to:

determine a third splicing position of the paused video;

determine a fourth splicing position of the continuation video; and

splice the fourth splicing position of the continuation video with the third splicing position of the paused video, until the recording of the continuation video ends, to obtain the target video.

In one embodiment, the processor is further configured to:

verify each frame of the paused video; and

determine the third splicing position based on a verification result of each frame of the paused video.

In the third aspect, the present disclosure also provides a video continuation device, including:

an obtaining module, configured to obtain a video to be processed, where the video to be processed includes a recorded video or a paused video that the recording device has currently paused recording, and the recording device is configured to pause recording during a recording process; and

a control module, configured to, in response to a user operation of the interactive device, control the recording device to record a continuation video, and when the video to be processed is the recorded video, generate a target video according to the recorded video and the continuation video; or when the video to be processed is the paused video that the recording device has currently paused recording, generate a target video according to the paused video and the continuation video.

In the fourth aspect, some embodiments of the present disclosure provide a computer device, including a memory and a processor, the memory stores a computer program, and when the processor executes the computer program, the processor implements the steps of the method provided in any embodiment of the first aspect.

In the fifth aspect, some embodiments of the present disclosure provide a computer-readable storage medium, on which a computer program is stored, and when the computer program is executed by a processor, the processor implements the steps of the method provided in any embodiment of the first aspect.

In the sixth aspect, some embodiments of the present disclosure also provide a computer program product, including a computer program, and when the computer program is executed by a processor, the processor implements the steps of the method provided in any embodiment of the first aspect.

The above method for continuing video recording and recording device obtain a video to be processed, where the video to be processed includes a recorded video or a paused video that the recording device has currently paused recording, and the recording device is configured to pause recording during a recording process. The above method for continuing video recording includes: in response to a user operation of the interactive device, controlling the recording device to record a continuation video, and when the video to be processed is the recorded video, generating a target video according to the recorded video and the continuation video; or when the video to be processed is the paused video that the recording device has currently paused recording, generating a target video according to the paused video and the continuation video. In this method, by operating the interactive device, it is possible to automatically form a target video that includes the recorded video and the newly recorded continuation video, or form a target video that includes the paused video that the recording device has currently paused recording and the newly recorded continuation video, reducing the work of manually editing and splicing videos, simplifying the video continuation work, and reducing the operational complexity of video continuation. Moreover, through the continuation function of the sports camera, multiple short videos can be synthesized into one large video during the recording process of the sports camera, solving the problem of large storage space occupied by multiple short video files, thereby saving the storage space of the sports camera.

### BRIEF DESCRIPTION OF DRAWINGS

To more clearly illustrate the technical solutions in the implementations of the present disclosure or the related art, the drawings required for the description of the implementations, or the related art will be briefly introduced below. It is evident that the drawings described below are merely examples of the present disclosure. For those skilled in the art, other drawings can be obtained based on the disclosed drawings without creative efforts.

FIG. 1 is an application environment diagram of a method for continuing video recording in one embodiment of the present disclosure.

FIG. 2 is a flowchart of a method for continuing video recording according to one embodiment of the present disclosure.

FIG. 3 is a flowchart of a first method for continuing video recording according to one embodiment of the present disclosure.

FIG. 4 is a flowchart of a second method for continuing video recording according to one embodiment of the present disclosure.

FIG. 5 is a flowchart of a third method for continuing video recording according to one embodiment of the present disclosure.

FIG. 6 is a flowchart of a fourth method for continuing video recording according to one embodiment of the present disclosure.

FIG. 7 is a flowchart of a fifth method for continuing video recording according to one embodiment of the present disclosure.

FIG. 8 is a flowchart of a sixth method for continuing video recording according to one embodiment of the present disclosure.

FIG. 9 is a flowchart of a seventh method for continuing video recording according to one embodiment of the present disclosure.

FIG. 10 is a flowchart of an eighth method for continuing video recording according to one embodiment of the present disclosure.

FIG. 11 is a flowchart of a ninth method for continuing video recording according to one embodiment of the present disclosure.

FIG. 12 is a flowchart of a tenth method for continuing video recording according to one embodiment of the present disclosure.

FIG. 13 is a flowchart of an eleventh method for continuing video recording to one embodiment of the present disclosure.

FIG. 14 is a flowchart of a twelfth method for continuing video recording according to one embodiment of the present disclosure.

FIG. 15 is a flowchart of a thirteenth method for continuing video recording according to one embodiment of the present disclosure.

FIG. 16 is a flowchart of a fourteenth method for continuing video recording according to one embodiment of the present disclosure.

FIG. 17 is a flowchart of a fifteenth method for continuing video recording according to one embodiment of the present disclosure.

FIG. 18 is a flowchart of a sixteenth method for continuing video recording according to one embodiment of the present disclosure.

FIG. 19 is a flowchart of a seventeenth method for continuing video recording according to one embodiment of the present disclosure.

FIG. 20 is a flowchart of an eighteenth method for continuing video recording according to one embodiment of the present disclosure.

FIG. 21 is a structural block diagram of a video continuation device according to one embodiment of the present disclosure.

FIG. 22 is an internal structural diagram of a computer device according to one embodiment of the present disclosure.

The present disclosure will be described with reference to the accompanying drawings.

### DETAILED DESCRIPTION

To make the objectives, technical solutions, and advantages of the present disclosure clearer, the following provides a detailed description of the present disclosure in conjunction with the accompanying drawings and embodiments. It should be understood that the specific embodiments described herein are merely for explaining the present disclosure and are not intended to limit the present disclosure.

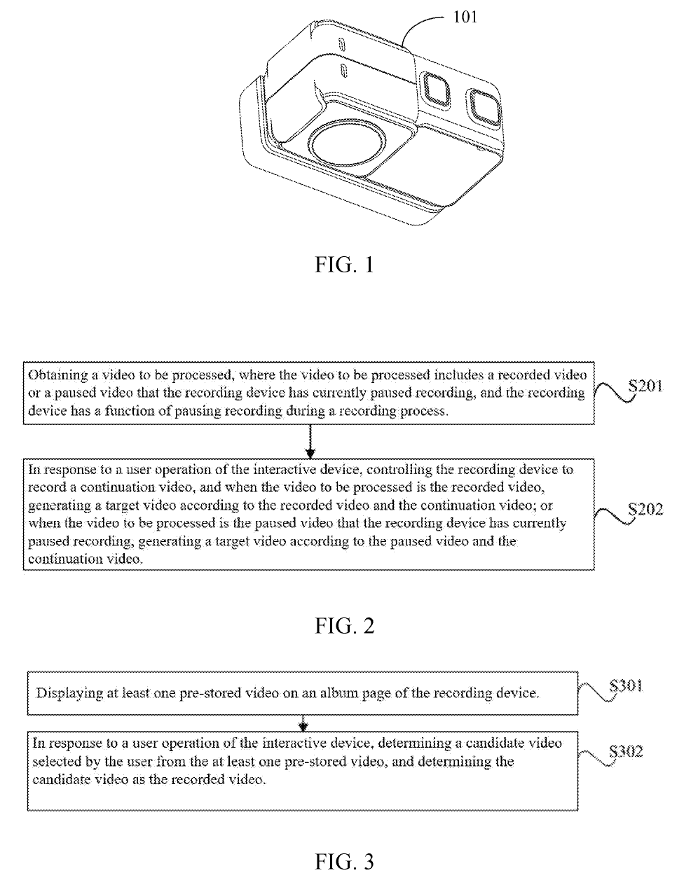

The method for continuing video recording provided by some embodiments of the present disclosure can be applied in the application environment shown in FIG. 1. Here, the recording device includes a camera and a computer device connected to the camera, where the recording device can be a recording device with a camera function, a mobile phone, or tablet with a camera, etc. For example, the recording device can be a sports camera 101. The computer device can be built into the recording device or connected externally. The computer device can be a terminal.

In some embodiments of the present disclosure, the camera of the sports camera can be configured to continue recording the video to be continued, thereby achieving continuation recording of the video to be processed.

In related technology, users need to record multiple short videos multiple times in the early stage and then use professional editing software in the later stage to edit these short videos, which not only consumes time but also requires a certain level of technical skill, making it quite complex. Moreover, each video file will have a certain header and tail, and the storage space required for multiple small files is also relatively large.

Based on this, in some aspects, the present disclosure provides a method for continuing video recording, obtaining a video to be processed, which includes a recorded video or a paused video that the recording device has currently paused recording. The recording device has a function of pausing recording during the recording process. The method may include: in response to a user operation of the interactive device, controlling the recording device to record a continuation video. In response to determining that the video to be processed is the recorded video, a target video can be generated according to the recorded video and the continuation video. In response to determining that the video to be processed is the paused video that the recording device has currently paused recording, a target video can be generated according to the paused video and the continuation video.

In this method, by operating the interactive device, automation can form a target video including the recorded video and the newly recorded continuation video, or form a target video including the paused video that the recording device has currently paused recording and the newly recorded continuation video, reducing the work of manually editing and splicing videos, simplifying the video continuation work, and reducing the operational complexity of video continuation.

Moreover, through the continuation function of the sports camera, multiple short videos can be synthesized into one large video during the recording process of the sports camera, solving the problem of large storage space occupied by multiple short video files, thereby saving the storage space of the sports camera.

In an exemplary embodiment, as shown in FIG. 2, a method for continuing video recording is provided, which can be applied to the recording device in FIG. 1 as an example for explanation. The recording device may include an interactive device, and the method may include the following steps.

S201: obtaining a video to be processed, where the video to be processed may include a recorded video or a paused video that the recording device has currently paused recording. The recording device may have a function of pausing recording during the recording process. In other words, the recording device can be configured to pause recording during a recording process.

The video to be processed can be a video that needs continuation recording, i.e., a new video needs to be continued on the video to be processed. In some examples, the video to be processed can be a recorded video pre-recorded by other cameras or recording devices. In some examples, it can be a video recorded by the recording device in the present disclosure embodiment before pausing recording during the recording process, i.e., a paused video.

The way to obtain the recorded video can be that there is a listener on the video playback page to monitor in real-time whether the user sends a video processing instruction. For example, the listener is a voice listener, and when entering the video playback page of the recording device, the voice listener automatically turns on, and the voice listener will monitor the user’s voice input in real-time. The user can issue a selection request for the video to be processed through a voice command, and the voice listener analyzes the user’s voice to determine whether the user has issued a selection request, and determines the video segment selected by the user as the video to be processed.

The way to obtain the paused video is that when the recording device is in a recording state, the recording device is controlled to record video, and the video recorded before pausing recording is determined as the paused video.

S202: in response to a user operation of the interactive device, controlling the recording device to record a continuation video. In response to determining that the video to be processed is the recorded video, a target video can be generated according to the recorded video and the continuation video. In response to determining that the video to be processed is the paused video that the recording device has currently paused recording, another target video can be generated according to the paused video and the continuation video.

In some embodiments, the interactive device can be a physical button of the recording device, and/or a touchable control on the touch screen of the recording device, and/or a remote control, etc.

The user can perform corresponding operations on the interactive device of the recording device according to actual needs. Different user needs may result in different or the same operations on the interactive device of the recording device.

In some embodiments, the continuation video can be the video recorded after the video to be processed.

In some embodiments, obtaining the continuation video recorded by the recording device may include the following: According to the video to be processed, the computer device can be configured to obtain the continuation request input by the user on the video to be processed, and continue recording the video to be processed according to the continuation request. The video after the video to be processed can be determined as the continuation video.

For instance, the interactive device can be a continuation button on the display interface of the video to be processed. When the user needs to continue the video to be processed, the user can click the continuation button on the page of the video to be processed, and the recording device responds to the user’s click on the continuation button on the page of the video to be processed. The user’s click on the continuation button on the page of the video to be processed can be the user’s input of a continuation request on the video to be processed.

Alternatively, the way the user inputs a continuation request on the video to be processed can also be that there is a listener on the page of the video to be processed to monitor in real-time whether the user inputs a continuation request on the video to be processed. For example, the listener is a voice listener, and when entering the page of the video to be processed, the voice listener automatically turns on, and the voice listener will monitor the user’s voice input in real-time. The user can issue a continuation request for the video to be processed through a voice command, and the voice listener analyzes the user’s voice to determine whether the user has issued a continuation request and sends the continuation request of the video to be processed to the computer device of the recording device.

After the computer device in the recording device receives the continuation request, it can control the camera in the recording device to continue recording, and after the recording is completed, obtain the continuation video corresponding to the video to be processed.

After obtaining the continuation video, the video to be processed and the continuation video can be used as the inputs to a preset video synthesis algorithm, running the video synthesis algorithm to determine the output of the video synthesis algorithm as the target video. The target video can include the video to be processed and the continuation video. In some embodiments, the target video can also include segments of the video to be processed and segments of the continuation video. It should be noted that the video synthesis algorithm can be determined according to the actual needs of the user.

In the case where the video to be processed is a recorded video, the video to be processed can be directly spliced with the continuation video to obtain the target video.

In the case where the video to be processed is a paused video, the paused video can also be processed, and the processed paused video can be spliced with the continuation video to obtain the target video.

The method for continuing video recording provided by some embodiments of the present disclosure obtains a video to be processed. The video to be processed may include a recorded video or a paused video that the recording device has currently paused recording. The recording device has a function of pausing recording during the recording process. In response to a user operation of the interactive device, the recording device can be controlled to record a continuation video. When the video to be processed is the recorded video, a target video can be generated according to the recorded video and the continuation video. When the video to be processed is the paused video that the recording device has currently paused recording, another target video can be generated according to the paused video and the continuation video.

In this method, by operating the interactive device, automation can form a target video including the recorded video and the newly recorded continuation video, or form another target video including the paused video that the recording device has currently paused recording and the newly recorded continuation video, reducing the work of manually editing and splicing videos, simplifying the video continuation work, and reducing the operational complexity of video continuation. Moreover, through the continuation function of the sports camera, multiple short videos can be synthesized into one large video during the recording process of the sports camera, solving the problem of large storage space occupied by multiple short video files, thereby saving the storage space of the sports camera.

In an exemplary embodiment, obtaining the recorded video includes: in response to a user operation of the interactive device, determining the recorded video.

The interactive device can be a touch screen in the recording device, and the user selects the video to be processed through the touch screen. Specifically, the way to determine the recorded video can be to obtain the recorded video in response to the confirmation request for the video to be processed sent by the user. The confirmation request can include the recorded video.

In some embodiments, the user can view all video segments on the video playback page of the recording device, and the video playback page includes a selection button. The user selects a video segment through the selection button, and the recording device determines the selected video segment as the recorded video in response to the user’s selection on the video playback page.

In some embodiments, the way to obtain the recorded video can also be that when the recording device is in a recording state, the user selects the end recording option through the interactive device to exit the recording state, and the recorded video is determined as the recorded video.

In the method for continuing video recording provided by some embodiments of the present disclosure, in response to a user operation of the interactive device, the recorded video is determined. In this method, by operating the interactive device of the recording device by the user, the recorded video is obtained, making the obtained recorded video more able to meet the user’s needs.

In an exemplary embodiment, as shown in FIG. 3, obtaining the recorded video includes:

S301: displaying at least one pre-stored video on an album page of the recording device.

In some embodiments, the album page of the recording device displays all video segments saved by the recording device, and these video segments are all pre-stored videos, including videos previously recorded by the recording device and videos sent to the recording device from other devices.

The user can enter the album page of the recording device, and the computer device of the recording device controls the recording device to display at least one pre-stored video to the user.

S302: in response to a user operation of the interactive device, determining a candidate video selected by the user from the at least one pre-stored video, and determining the candidate video as the recorded video.

The user can operate the interactive device to select a video from at least one pre-stored video, determine the video selected by the user as the candidate video, and then determine the candidate video as the recorded video.

In the method for continuing video recording provided by some embodiments of the present disclosure, at least one pre-stored video is displayed on the album page of the recording device, and in response to a user operation of the interactive device, the candidate video selected by the user from at least one pre-stored video is determined, and the candidate video is determined as the recorded video. In this method, the recorded video selected by the user from the pre-stored videos of the recording device improves the effectiveness and accuracy of obtaining the recorded video.

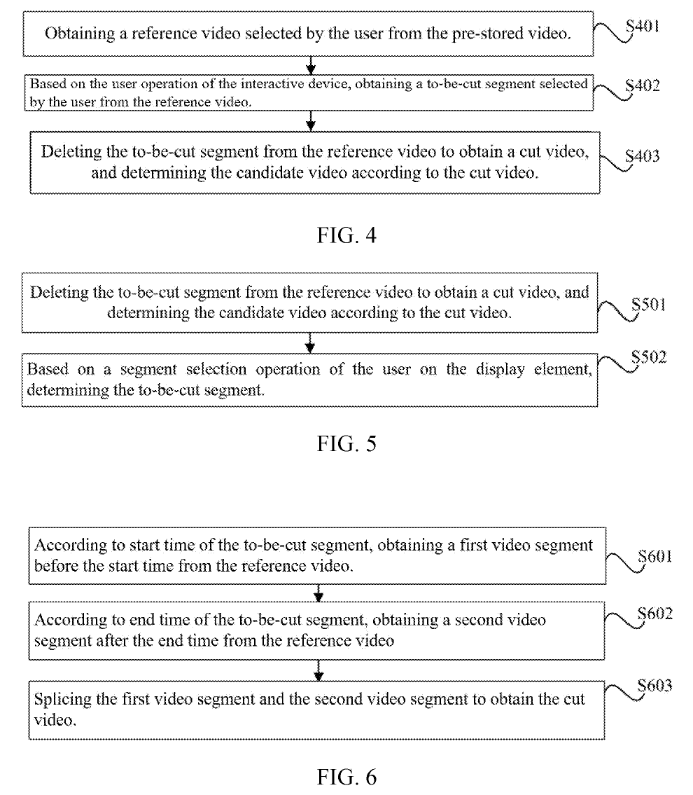

In an exemplary embodiment, as shown in FIG. 4, in response to a user operation of the interactive device, determining the candidate video selected by the user from at least one pre-stored video includes the following steps:

S401: obtaining a reference video selected by the user from the pre-stored video.

In some embodiments, the reference video is any video selected by the user from the pre-stored video.

The user can select a video from at least one pre-stored video according to their actual needs, and determine the video selected by the user as the reference video.

S402: based on the user operation of the interactive device, obtaining a to-be-cut segment selected by the user from the reference video.

In an exemplary embodiment, as shown in FIG. 5, based on the user operation of the interactive device, obtaining the to-be-cut segment selected by the user from the reference video includes the following steps.

S501: in a case where the user performs a trim activation operation on the interactive device, displaying a display element corresponding to the reference video.

The recording device includes a trim activation operation, and the user can perform a trim activation operation through the interactive device. The computer device responds to the trim activation operation performed by the user on the interactive device and displays the display element of the reference video to the user through the display screen of the recording device.

In some embodiments, the display element can be a progress bar of the reference video.

S502: based on a segment selection operation of the user on the display element, determining the to-be-cut segment.

The user can perform a segment selection operation on the display element of the reference video and determine the video segment corresponding to the segment selection operation as the to-be-cut segment.

For example, in the interface of the segment selection operation, there is also a cut box and a confirm cut button. The cut box corresponds to the length of the trimmed video segment, and the user can adjust the cut box according to the cutting needs, enlarging or reducing the cut box. For example, the display element of the reference video shows the reference video as 0~10s, and the user wants to trim the video segment of about 5~8 seconds. Therefore, the user can adjust the cut box and move the cut box to the video segment of 5s to 8s according to the display element of the reference video, and then the user clicks the confirm cut button, thereby sending the to-be-cut segment of 5s to 8s to the computer device of the recording device, thereby obtaining the to-be-cut segment selected by the user from the reference video.

In some embodiments, if the to-be-cut segment that the user needs to trim is the video segment from a previous moment to the current moment, the user can drag the progress bar in the reference video to the previous moment, and then take the video segment between the previous moment and the current moment as the to-be-cut segment and send it to the computer device.

It should be noted that the to-be-cut segment is the video segment that the user wants to delete from the reference video. The to-be-cut segment can be multiple video segments, i.e., the user can select multiple to-be-cut segments in the reference video. For example, the reference video is about 0~10s, and the to-be-cut segment can be the video segments of about 2~5s and about 8~10s.

S403: deleting the to-be-cut segment from the reference video to obtain a trimmed video, and determining the candidate video according to the trimmed video.

Deleting the to-be-cut segment from the reference video and splicing the remaining segments in the reference video to obtain the trimmed video of the reference video, and then determining the trimmed video as the candidate video.

Taking the reference video including one to-be-cut segment as an example, in an exemplary embodiment, as shown in FIG. 6, deleting the to-be-cut segment from the reference video to obtain the trimmed video includes the following steps.

S601: according to start time of the to‑be‑cut segment, obtaining a first video segment before the start time from the reference video.

S602: according to end time of the to‑be‑cut segment, obtaining a second video segment after the end time from the reference video.

S603: splicing the first video segment and the second video segment to obtain the trimmed video.

Obtaining the start time and end time of the to-be-cut segment, and according to the start time of the to-be-cut segment, obtaining the first video segment collected before the start time from the reference video, and according to the end time of the to-be-cut segment, obtaining the second video segment collected after the end time from the reference video, and then splicing the end time of the first video segment and the start time of the second video segment to obtain the trimmed video of the reference video. The trimmed video includes the first video segment and the second video segment.

Continuing with the example of the reference video including 0~10s, if the to-be-cut segment is 5~8s, then the first video segment is 0~5s, the second video segment is 8~10s, and then the video segments of 0~5s and 8~10s are spliced together to obtain the trimmed video of the reference video.

It should be noted that if the to-be-cut segment in the reference video includes multiple segments, then based on the same principle as above, the to-be-cut segment is deleted from the reference video, and the remaining segments are spliced together in sequence according to the recording time.

In some embodiments of the present disclosure, according to the start time of the to-be-cut segment, obtain the first video segment before the start time from the reference video, and according to the end time of the to-be-cut segment, obtain the second video segment after the end time from the reference video, and then splice the first video segment and the second video segment to obtain the trimmed video. The user can selectively trim specific parts of the video as needed, removing unwanted content or extracting important segments. By cutting the video, redundant or irrelevant content is removed, improving the viewing experience and the effectiveness of conveying information.

The way to determine the video to be processed according to the trimmed video can also be to verify the trimmed video and determine the video to be processed according to the verification result, e.g., verifying each frame of the trimmed video, and if each frame of the video passes the verification, determining the trimmed video as the video to be processed. If there are video frames in the trimmed video that do not pass the verification, delete the video frames that do not pass the verification from the trimmed video, and determine the trimmed video after deleting the video frames that do not pass the verification as the video to be processed.

The method for continuing video recording provided by some embodiments of the present disclosure includes: obtaining the reference video selected by the user from the pre-stored video, and based on the user operation of the interactive device, obtaining the to-be-cut segment selected by the user from the reference video, and then deleting the to-be-cut segment from the reference video to obtain the trimmed video, and determining the candidate video according to the trimmed video. By selecting the reference video from the pre-stored video by the user, and then selecting the to-be-cut segment in the reference video and deleting part of the segments in the reference video, all video frames in the trimmed video the videos are needed by the user, reducing redundant segments, improving the video effect of the trimmed video, and avoiding the user from further processing the video later.

In an exemplary embodiment, obtaining the recorded video includes: based on the user operation of the interactive device of the recording device, determining the pre-stored video, and cutting the pre-stored video to obtain the recorded video.

In some embodiments, the pre-stored video can be the video stored in the video playback page or memory of the recording device.

Taking the video playback page as an example, the user can operate the interactive device of the recording device to enter the video playback page of the recording device. The user selects a video in the video playback page according to his/her needs, and determines the video selected by the user in the video playback page as the pre-stored video.

In some embodiments, the pre-stored video can be a video segment recorded by the recording device, or it can be a video segment recorded by other recording devices.

The pre-stored video can be cut according to a preset cutting strategy, and the cut pre-stored video is determined as the recorded video.

The way to cut the pre-stored video can be to delete a preset duration at a preset position in the pre-stored video, and determine the pre-stored video after deletion as the video to be processed. For example, delete the last 2s of video in the pre-stored video to obtain the video to be processed.

The way to cut the pre-stored video can also be to verify each frame of the video frame in the pre-stored video, and if each frame of the video passes the verification, then determine the pre-stored video as the recorded video. If there are video frames in the pre-stored video that do not pass the verification, then delete the video frames that do not pass the verification from the pre-stored video, and determine the pre-stored video after deleting the video frames that do not pass the verification as the recorded video.

The method for continuing video recording provided by some embodiments of the present disclosure includes: based on the user operation of the interactive device of the recording device, determining the pre-stored video, and cutting the pre-stored video to obtain the recorded video. In this method, by cutting the pre-stored video, the recorded video is obtained, so that the pre-stored video can be cut according to the user’s needs to obtain the recorded video that meets the user’s needs, making the obtained recorded video more accurate.

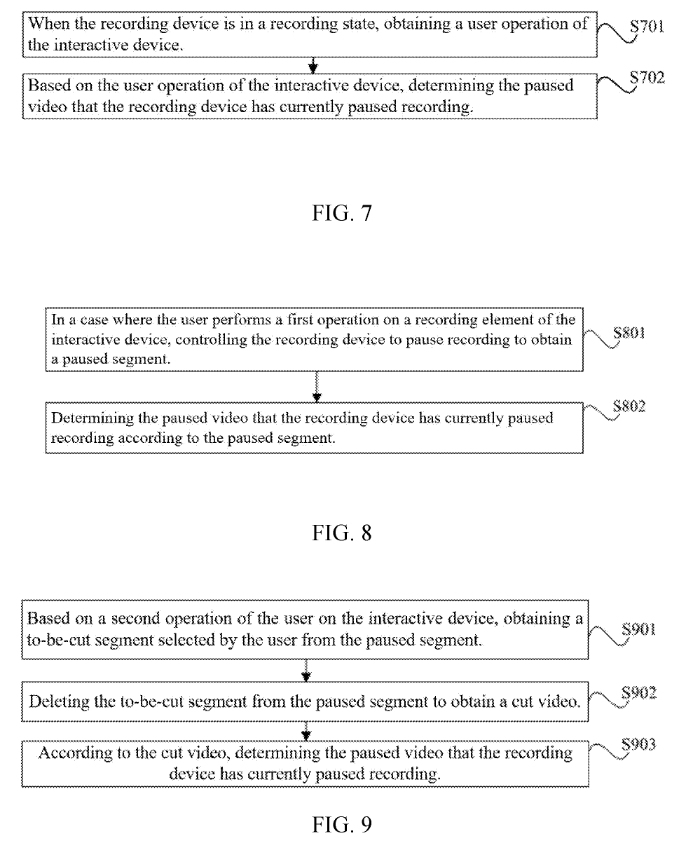

In an exemplary embodiment, as shown in FIG. 7, obtaining the paused video that the recording device has currently paused recording includes the following steps.

S701: when the recording device is in a recording state, obtaining a user operation of the interactive device.

When the recording device is in a recording state, the user can operate the interactive device of the recording device. The definition of the interactive device is the same as in the above embodiments, and this embodiment will not be repeated here.

S702: based on the user operation of the interactive device, determining the paused video that the recording device has currently paused recording.

In an exemplary embodiment, as shown in FIG. 8, based on the user operation of the interactive device, determining the paused video that the recording device has currently paused recording includes the following steps.

S801: in a case where the user performs a first operation on a recording element of the interactive device, controlling the recording device to pause recording to obtain a paused segment.

In some embodiments, the first operation can be a pause operation, which is equivalent to controlling the recording device to be in a paused recording state. The recording element of the interactive device can be a shutter button on the recording device, or a control button on the remote control of the recording device, etc.

Taking the shutter button as an example of the recording element of the interactive device, when the recording device is in a recording state, the user can click the shutter button, and the computer responds to the first operation performed by the user on the interactive device of the recording device, and can control the recording device to be in a paused recording state, and determine the video recorded before the first operation is triggered as the paused segment.

S802: determining the paused video that the recording device has currently paused recording according to the paused segment.

The paused segment can be directly determined as the paused video that the recording device has currently paused recording.

The method for continuing video recording provided by some embodiments of the present disclosure includes: when the recording device is in a recording state, obtaining a user operation of the interactive device, and based on the user operation of the interactive device, determining the paused video that the recording device has currently paused recording. In this way, when the recording device is in a recording state, the paused video is determined, so that the video being recorded can be processed, reducing the steps of processing the video after the recording is completed, thereby improving the efficiency and accuracy of video processing.

Below are some implementation methods for determining the video to be processed according to the paused segment. In an exemplary embodiment, as shown in FIG. 9, determining the paused video that the recording device has currently paused recording according to the paused segment includes the following steps.

S901: based on a second operation of the user on the interactive device, obtaining a to-be-cut segment selected by the user from the paused segment.

In some embodiments, the second operation can be a trim activation operation. In the case where the user performs a trim activation operation on the recording element of the interactive device, the to-be-cut segment selected by the user from the paused segment is obtained.

In some embodiments, the trim activation operation can be a pre-set operation. For example, the way the user performs the trim activation operation on the interactive device can be that the user continuously triggers the recording element of the interactive device for a preset duration.

In some embodiments, the way the user performs the trim activation operation on the interactive device can also be that when the recording device is in a recording state, the user can long-press the recording element for 1s to achieve the trim activation operation. At this time, the screen of the recording device can display “Cancel Recording Function Option” and “Trimmed video Function Option,” and the user clicks the “Trimmed video Function Option.” After the user clicks the “Trimmed video Function Option,” obtaining the to-be-cut segment selected by the user from the paused segment, where the to-be-cut segment can be the video segment that the user does not want.

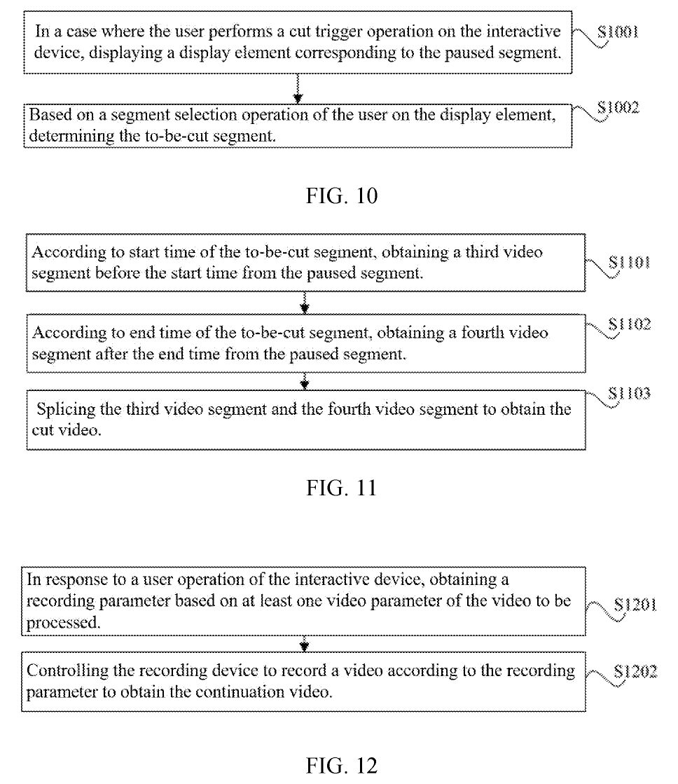

In an exemplary embodiment, as shown in FIG. 10, based on the second operation of the user on the interactive device, obtaining the to-be-cut segment selected by the user from the paused segment includes the following steps.

S1001: in a case where the user performs a trim activation operation on the interactive device, displaying a display element corresponding to the paused segment.

In the case where the user performs a trim activation operation on the interactive device, i.e., when the user selects to trim the video, the computer device can obtain the paused segment collected by the recording device before the trim activation operation is performed, and display the paused segment on the screen of the recording device, so that the user can cut the paused segment.

In some embodiments, the display element corresponding to the paused segment can be a progress bar, so the computer device can display the paused segment and the corresponding progress bar on the screen of the recording device.

S1002: based on a segment selection operation of the user on the display element, determining the to-be-cut segment.

The implementation method of determining the to-be-cut segment based on the segment selection operation of the user on the display element in some embodiments of the present disclosure is the same as the implementation method of determining the to-be-cut segment based on the segment selection operation of the user on the display element in the above embodiments, and this embodiment will not be repeated here.

S902: deleting the to-be-cut segment from the paused segment to obtain a trimmed video.

The to-be-cut segment is deleted from the paused segment and the remaining segments in the paused segment are spliced to obtain the trimmed video of the paused segment.

In an exemplary embodiment, as shown in FIG. 11, deleting the to-be-cut segment from the paused segment to obtain the trimmed video includes the following steps.

S1101: according to the start time of the to‑be‑cut segment, obtaining a third video segment before the start time from the paused segment.

S1102: according to the end time of the to‑be‑cut segment, obtaining a fourth video segment after the end time from the paused segment, according to the end time of the to-be-cut segment.

S1103: splicing the third video segment and the fourth video segment to obtain the trimmed video.

Obtain the start time and end time of the to-be-cut segment, and according to the start time of the to-be-cut segment, obtain the third video segment collected before the start time from the paused segment, and according to the end time of the to-be-cut segment, obtain the fourth video segment collected after the end time from the paused segment, and then splice the end time of the third video segment and the start time of the fourth video segment to obtain the trimmed video of the paused segment. The trimmed video includes the third video segment and the fourth video segment.

Continuing with the example of the paused segment including 0~10s, if the to-be-cut segment is 5~8s, then the third video segment is 0~5s, the fourth video segment is 8~10s, and then the video segments of 0~5s and 8~10s are spliced together to obtain the trimmed video of the paused segment.

It should be noted that if the to-be-cut segment in the paused segment includes multiple segments, then based on the same principle as above, the to-be-cut segment is deleted from the paused segment, and the remaining segments are spliced together in sequence according to the recording time.

S903: determining the paused video that the recording device has currently paused recording according to the trimmed video.

The trimmed video can be determined as the paused video that the recording device has currently paused recording, or the trimmed video can be verified, and the paused video that the recording device has currently paused recording can be determined according to the verification result. Specifically, verify each frame of the video frame in the trimmed video, if each frame of the video passes the verification, then determine the trimmed video as the paused video that the recording device has currently paused recording. If there are video frames in the trimmed video that do not pass the verification, then delete the video frames that do not pass the verification from the trimmed video, and determine the trimmed video after deleting the video frames that do not pass the verification as the paused video that the recording device has currently paused recording.

The method for continuing video recording provided by some embodiments of the present disclosure includes: based on the second operation of the user on the interactive device, obtaining the to-be-cut segment selected by the user from the paused segment, and deleting the to-be-cut segment from the paused segment to obtain the trimmed video, and determining the trimmed video as the paused video that the recording device has currently paused recording. In this method, by cutting the paused segment, the paused video that the recording device has currently paused recording is obtained, so that the paused segment can be cut according to the user’s needs to obtain the video to be processed that meets the user’s needs, making the obtained paused video more accurate.

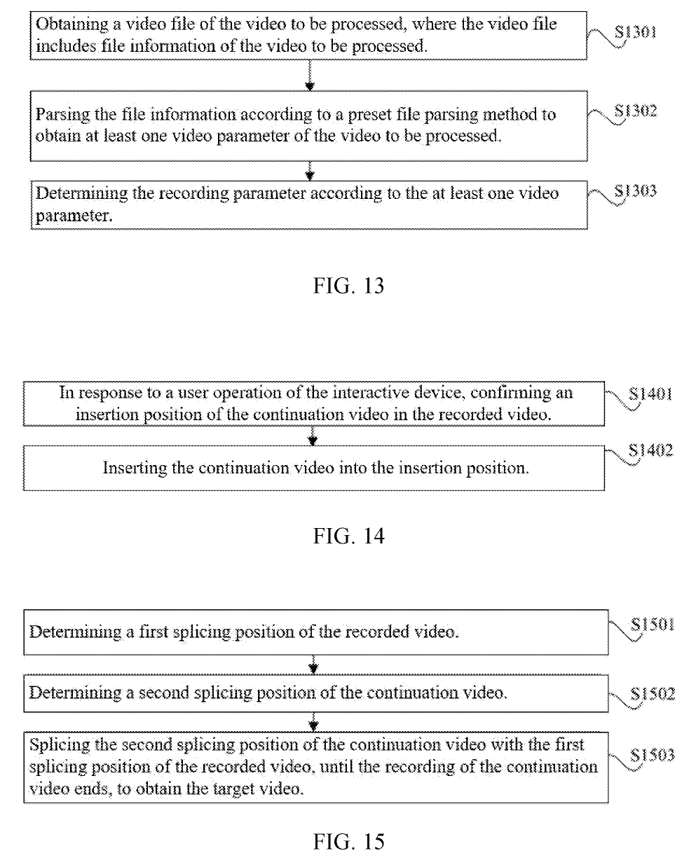

In an exemplary embodiment, as shown in FIG. 12, in response to a user operation of the interactive device, controlling the recording device to record a continuation video includes the following steps.

S1201: in response to a user operation of the interactive device, obtaining a recording parameter based on at least one video parameter of the video to be processed.

In some embodiments, after the computer device of the recording device obtains the video to be processed, the user can perform a third operation on the interactive device, where the third operation can include the user clicking the continuation button on the video to be processed. The computer device responds to the user operation of the interactive device, and can parse the video to be processed through a preset video parameter parsing algorithm to obtain at least one video parameter of the video to be processed. Specifically, the video to be processed is used as the input of the video parameter parsing algorithm, and the video parameter parsing algorithm is run to obtain at least one video parameter of the video to be processed. In some embodiments, the video parameter can include resolution, shutter speed, aperture, exposure parameters, etc.

At least one video parameter of the video to be processed is determined as the recording parameter, where the recording parameter is the recording parameter corresponding to the video to be processed.

S1202: controlling the recording device to record a video according to the recording parameter to obtain the continuation video.

Based on the obtained recording parameter, the computer device can adjust the recording parameter of the recording device, and record the new video through the adjusted recording parameter, determining the newly recorded video as the continuation video.

The method for continuing video recording provided by some embodiments of the present disclosure includes: in response to a user operation of the interactive device, first determining the video to be processed selected by the user, then obtaining the recording parameter based on at least one video parameter of the video to be processed, and then controlling the recording device to record a video according to the recording parameter to obtain the continuation video. Using the recording parameter of the video to be processed to control the recording device to record a video is equivalent to the continuation video having the same image effect as the video to be processed, thereby improving the image connection effect of the complete video obtained from the video to be processed and the continuation video.

In one embodiment, as shown in FIG. 13, obtaining the recording parameter based on at least one video parameter of the video to be processed includes the following steps.

S1301: obtaining a video file of the video to be processed, where the video file includes file information of the video to be processed.

The video to be processed carries a video identifier of the video to be processed, and when the computer device determines the video to be processed, it can also determine the video identifier of the video to be processed, where the video identifier can be a symbol, string, or number used to uniquely identify a video, and the video identifier can be a video name, video ID, etc.

The database of the recording device stores video files corresponding to videos, where the video file corresponds to the video identifier. Therefore, according to the video identifier of the video to be processed, the video file corresponding to the video identifier of the video to be processed can be directly obtained from the database, and the video file includes file information of the video to be processed.

In some embodiments, the file information of the video to be processed can include an image file and an audio file of the video to be processed.

S1302: parsing the file information according to a preset file parsing method to obtain at least one video parameter of the video to be processed.

In some embodiments, the video parameter can include video encoding format, audio encoding format, resolution, exposure mode, image configuration parameters, shutter speed, aperture, exposure parameters, etc., where the exposure mode includes manual exposure or automatic exposure.

Before parsing the file information, the format of the video file can be detected, and the file parsing method corresponding to the format of the video file can be obtained according to the format of the video file, and then the file information of the video to be processed in the video file can be parsed according to the file parsing method, thereby obtaining at least one video parameter corresponding to the file information. The video parameter is the parameter used in the process of recording the video to be processed.

In some embodiments, the file format of the video file can be directly determined according to the suffix name of the video file, where the database of the recording device includes the corresponding relationship between the file format and the file parsing method, and each file parsing method corresponds to a file parsing algorithm.

Therefore, the file information of the video file can be parsed according to the file parsing algorithm of the video file, and at least one video parameter corresponding to the file information can be obtained. For example, the file format of the video file can be MP4 format, and the file information of the video file can be parsed using the parsing algorithm or parsing tool corresponding to the MP4 format to obtain at least one video parameter corresponding to the file information.

S1303: determining the recording parameter according to at least one video parameter.

In some embodiments, at least one video parameter is all video parameters obtained after parsing the file information.

All of at least one video parameter can be determined as the recording parameter. In this way, recording with the same recording parameter as the video to be processed ensures that the newly recorded continuation video and the video to be processed can maintain consistency in image effect, thereby improving the coherence of the complete video.

In some embodiments, the recording parameter can also be determined according to multiple video parameters that affect the video shooting effect obtained from all video parameters of the parsed file information. For example, the video parameters of the parsed file information include parameter A, parameter B, parameter C, and parameter D, where the setting of parameter D does not affect the shooting effect, so the recording parameter can be determined according to parameter A, parameter B, and parameter C.

The method for continuing video recording provided by some embodiments of the present disclosure includes: obtaining a video file of the video to be processed, where the video file includes file information of the video to be processed; and parsing the file information according to a preset file parsing method to obtain at least one video parameter of the video to be processed, and then determining the recording parameter according to at least one video parameter. In this method, parsing the file information according to a preset file parsing method improves the efficiency and accuracy of file parsing, thereby quickly obtaining accurate video parameters, and then determining the recording parameter according to the video parameters, resulting in higher recording quality according to the recording parameter.

In an exemplary embodiment, controlling the recording device to record a video according to the recording parameter to obtain the continuation video includes the following steps: detecting whether a condition for stopping recording is met, and if the condition for stopping recording is met, controlling the recording device to stop recording to obtain the continuation video.

In some embodiments, the condition for stopping recording includes at least one of the following: a stop recording instruction input by a user is received; a duration of the current continuation recording reaches a preset recording duration; or a current memory space reaches a preset memory space occupation threshold.

In some embodiments, the stop recording instruction includes receiving a stop recording instruction input by a user. In some embodiments, the continuation interface of the video to be processed includes a stop recording button, and the user can click the stop recording button on the continuation interface of the video to be processed. The user’s click on the stop recording button triggers the stop recording instruction, so after the user clicks the stop recording button, the computer device of the recording device can receive the stop recording instruction input by the user, and after receiving the stop recording instruction, the computer device can control the camera to stop recording to obtain the continuation video.

In some embodiments, the stop recording instruction can also include a stop recording duration. For example, after the computer device receives the stop recording instruction, it continues recording for the stop recording duration and then controls the recording device to stop recording to obtain the continuation video. For example, the stop recording duration includes 5s, and after the computer device receives the stop recording instruction input by the user, it continues recording for 5s and can control the camera of the recording device to stop recording after 5s to obtain the continuation video.

If the condition for stopping recording includes the duration of the current continuation recording reaching the preset recording duration, then controlling the recording device to stop recording to obtain the continuation video includes: the computer device controls the camera of the recording device to record according to the recording parameter, and when the recording duration reaches the preset recording duration, the computer device controls the camera of the recording device to stop recording to obtain the continuation video. For example, the preset recording duration is 60s, for example, after the computer device controls the camera of the recording device to record for 60s, the computer device then controls the camera of the recording device to stop recording.

If the condition for stopping recording includes the current memory space reaching the preset memory space occupation threshold, then controlling the recording device to stop recording to obtain the continuation video includes: during the process of recording according to the recording parameter by the recording device, if it is detected that the current memory space of the recording device reaches the preset memory space occupation threshold, then control the camera of the recording device to stop recording.

After the recording device stops recording, the continuation video is obtained, where the continuation video is the newly recorded video by the recording device.

The method for continuing video recording provided by some embodiments of the present disclosure includes: detecting whether a condition for stopping recording is met; and if the condition for stopping recording is met, controlling the recording device to stop recording to obtain the continuation video. In this method, by setting the condition for stopping recording, recording is stopped when the condition for stopping recording is met, improving the effectiveness of the continuation video, and avoiding recording segments without content or invalid segments.

In an exemplary embodiment, as shown in FIG. 14, generating a target video according to the recorded video and the continuation video includes the following steps.

S1401: in response to a user operation of the interactive device, confirming an insertion position of the continuation video in the recorded video.

The user can operate the marking element of the interactive device to determine the insertion position of the continuation video in the recorded video.

The recorded video includes a progress bar, and the user can drag the progress bar to a certain position in the recorded video, and then trigger the marking element of the interactive device to mark the position in the recorded video, determining the position as the insertion position.

In some embodiments, the marking element can be a marking button on the recording device, or a marking button on the remote control, etc.

S1402: inserting the continuation video into the insertion position.

The continuation video can be a video segment recorded by the recording device for the continuation of the recorded video. The computer device can insert the continuation video at the insertion position of the processed video.

For example, the recorded video includes a video of 0-10s, the insertion position is the 5th second of the recorded video, and the continuation video is a video segment of 4s, then the 4s video segment can be inserted from the 5s position of the recorded video, obtaining a 14s inserted video.

In some embodiments, before inserting the continuation video into the insertion position, it further includes: deleting a target segment after the insertion position in the recorded video.

The video segment after the insertion position in the recorded video is determined as the target segment, and then the target segment is deleted.

For example, the recorded video includes a video of 0-10s, and the insertion position is the 5th second of the recorded video. The video segment after the 5^{th} second in the recorded video is deleted, and the continuation video is appended starting from the 5th second of the recorded video.

The method for continuing video recording provided by some embodiments of the present disclosure includes: in response to a user operation of the interactive device, confirming an insertion position of the continuation video in the recorded video, and inserting the continuation video into the insertion position. In this method, the computer device can insert the continuation video into the recorded video, thereby achieving editing and modification of the recorded video, meeting the user’s specific needs for the video.

In an exemplary embodiment, generating a target video according to the recorded video and the continuation video includes: splicing the recorded video and the continuation video to generate the target video.

In some embodiments, the target video can include the recorded video and the continuation video.

The end position of the recorded video and the start position of the continuation video can be spliced together to obtain the target video.

In some embodiments, the continuation video can also be spliced from any time point of the recorded video. For example, the recorded video frame is 1~30 seconds, the first splicing video can be a video of 1~25s, cutting the video of 25~30s, and continuing recording from 25s.

It should be noted that the splicing position between the recorded video and the continuation video can be determined according to actual needs.

The method for continuing video recording provided by some embodiments of the present disclosure includes splicing the recorded video and the continuation video to generate the target video. In this method, the recorded video and the continuation video are spliced to form a target video including the recorded video and the newly recorded video, reducing the work of manually editing and splicing videos, simplifying the video continuation work, and reducing the operational complexity of video continuation. Moreover, through the continuation function of the recording device, multiple short videos can be synthesized into one complete large video during the recording process of the recording device, solving the problem of large storage space occupied by multiple short video files, thereby saving the storage space of the recording device.

In an exemplary embodiment, as shown in FIG. 15, splicing the recorded video and the continuation video to generate the target video includes the following steps.

S1501: determining a first splicing position of the recorded video.

In some embodiments, the first splicing position is the position in the recorded video where the continuation video is spliced.

The first splicing position can also be manually selected by the user in the recorded video and sent to the computer device of the recording device, or the recorded video can be input into a pre-trained video selection model, and the video selection model analyzes the recorded video to output the first splicing position.

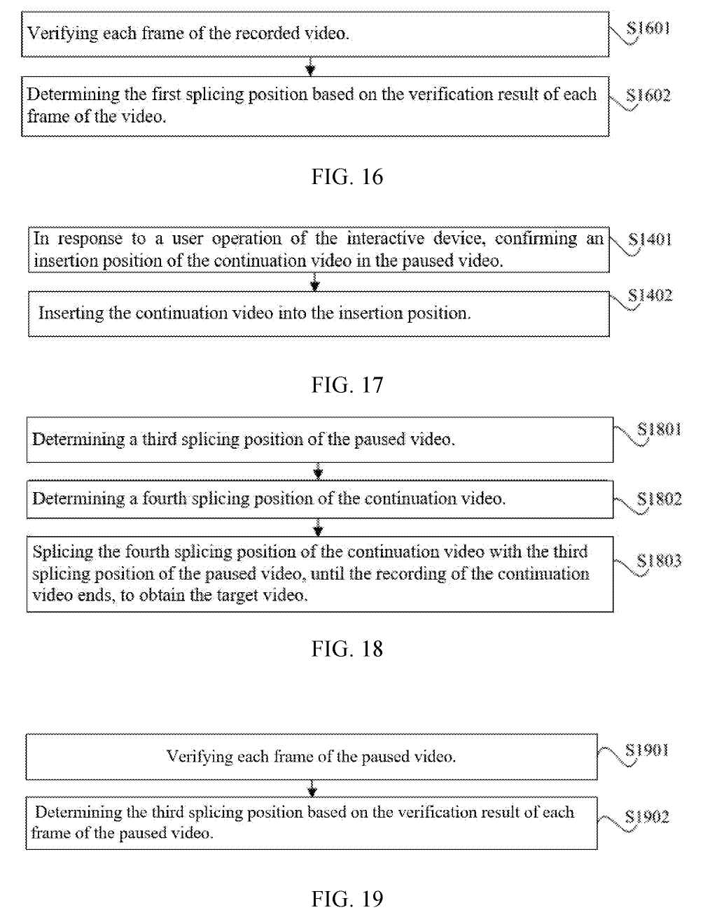

In some embodiments, as shown in FIG. 16, determining the first splicing position of the recorded video includes the following steps.

S1601: verifying each frame of the recorded video.

After the computer device of the recording device obtains the recorded video, it can verify the quality of each frame of the recorded video to determine whether the recorded video meets the requirements. For example, the resolution of each frame of the recorded video can be verified, and it can also be determined whether there is a blurred image in each frame of the video, etc. If there is a blurred image in the video frame, it is determined that the video frame does not pass the verification, and if there is no blurred image in the video frame, it is determined that the video frame passes the verification.

S1602: determining the first splicing position based on the verification result of each frame of the video.

In some embodiments, the first splicing position can be the splicing position of the recorded video with the continuation video.

If all video frames of the recorded video pass the verification, it indicates that the quality of all video frames in the recorded video meets the conditions, and the last frame of the recorded video can be used as the first splicing position.

If a certain video frame in the recorded video does not pass the verification, it indicates that the quality of the video frame does not meet the conditions, and the video frame can be removed, and the frame before the video frame that does not pass the verification in the recorded video can be used as the first splicing position. In some embodiments, if there are multiple video frames in the recorded video that do not pass the verification, the frame before the earliest video frame collected in the video frames that do not pass the verification can be used as the first splicing position. For example, if the video frames that do not pass the verification in the recorded video are the 5th frame, the 7th frame, and the 10th frame, then the 4th frame before the 5th frame can be used as the first splicing position.

The method for continuing video recording provided by some embodiments of the present disclosure includes: verifying each frame of the recorded video; and determining the first splicing position based on the verification result of each frame of the video. In this method, by verifying each frame of the recorded video, and based on the verification result of the video frame, the first splicing position can be accurately determined from the recorded video.

S1502: determining a second splicing position of the continuation video.

In some embodiments, the second splicing position can be the splicing position of the continuation video with the recorded video.

Each frame of the continuation video can also be verified, and the second splicing video frame can be determined based on the verification result of each frame of the continuation video. Specifically, the quality of each frame of the continuation video can be verified to determine whether the recorded video meets the requirements. For example, the resolution of each frame of the continuation video can be verified, and it can also be determined whether there is a blurred image in each frame of the video, etc. If there is a blurred image in the video frame, it is determined that the video frame does not pass the verification, and if there is no blurred image in the video frame, it is determined that the video frame passes the verification.

If all video frames of the continuation video pass the verification, the first frame of the continuation video can be used as the second splicing position. If there are video frames in the continuation video that do not pass the verification, the frame after the latest video frame collected in the video frames that do not pass the verification can be used as the second splicing position. For example, if the video frames that do not pass the verification in the continuation video are the 5th frame, the 7th frame, and the 10th frame, then the 11th frame after the 10th frame can be used as the second splicing position.

In some embodiments, the second splicing position can also be manually selected by the user in the continuation video and sent to the computer device of the recording device, or the continuation video can be input into a pre-trained video selection model, and the video selection model analyzes the recorded video to output the second splicing position.

S1503: splicing the second splicing position of the continuation video with the first splicing position of the recorded video, until the recording of the continuation video ends, to obtain the target video.

In some embodiments, the continuation video starting from the second splicing position can be spliced with the recorded video at the first splicing position, until the recording of the continuation video ends. The target video can include at least one video segment in the recorded video and the continuation video, and the target video includes the video frames in the recorded video before the first splicing position, and the video frames in the continuation video after the second splicing position.

In some embodiments, the recorded video and the continuation video can be spliced through the first splicing position and the second splicing position to obtain the target video.

The method for continuing video recording provided by some embodiments of the present disclosure includes: determining the first splicing position of the recorded video, determining the second splicing position of the continuation video, and then splicing the second splicing position of the continuation video with the first splicing position of the recorded video, until the recording of the continuation video ends, to obtain the target video. In this method, the first splicing video frame of the recorded video and the second video frame of the continuation video are spliced together to obtain the target video, making the obtained target video more effective and accurate.

In an exemplary embodiment, as shown in FIG. 17, generating a target video according to the paused video and the continuation video includes the following steps.

S1701: in response to a user operation of the interactive device, confirming an insertion position of the continuation video in the paused video.

The user can operate the marking element of the interactive device to determine the insertion position of the continuation video in the paused video.

The paused video includes a progress bar, and the user can drag the progress bar to a certain position in the paused video, and then trigger the marking element of the interactive device to mark the position in the paused video, determining the position as the insertion position.

In some embodiments, the marking element can be a marking button on the recording device, or a marking button on the remote control, etc.

S1702: inserting the continuation video into the insertion position.

The continuation video can be a video segment recorded by the recording device for the continuation of the paused video. The computer device can insert the continuation video at the insertion position of the processed video.

For example, the paused video includes a video of 0~10s, the insertion position is the 5th second of the paused video, and the continuation video is a video segment of 4s, then the 4s video segment can be inserted from the 5s position of the paused video, and the inserted video is 14s.

In some embodiments, before inserting the continuation video into the insertion position, it further includes: deleting a target segment after the insertion position in the paused video.

The video segment after the insertion position in the paused video is determined as the target segment, and then the target segment is deleted.

For example, the paused video includes a video of 0~10s, and the insertion position is the 5th second of the paused video. The video segment after the 5th second in the paused video is deleted, and the continuation video is appended starting from the 5th second of the paused video.

The method for continuing video recording provided by some embodiments of the present disclosure includes: in response to a user operation of the interactive device, confirming an insertion position of the continuation video in the paused video, and inserting the continuation video into the insertion position. In this method, the computer device can insert the continuation video into the paused video, thereby achieving editing and modification of the paused video, and meeting the user’s specific needs for the video.

In an exemplary embodiment, generating a target video according to the paused video and the continuation video includes: splicing the paused video and the continuation video to generate the target video.

In some embodiments, the target video can include the paused video and the continuation video.

The end position of the paused video and the start position of the continuation video can be spliced together to obtain the target video.

In some embodiments, the continuation video can also be spliced from any time point of the paused video. For example, the paused video frame is 1~30 seconds, the first splicing video can be a video of 1~25s, cutting the video of 25~30s, and continuing recording from 25s.

It should be noted that the splicing position between the paused video and the continuation video can be determined according to actual needs.

In the method for continuing video recording provided by some embodiments of the present disclosure, splicing the paused video and the continuation video to generate the target video. In this method, the paused video and the continuation video are spliced to form a target video including the paused video and the newly recorded video, reducing the work of manually editing and splicing videos, simplifying the video continuation work, and reducing the operational complexity of video continuation. Moreover, through the continuation function of the recording device, multiple short videos can be synthesized into one complete large video during the recording process of the recording device, solving the problem of large storage space occupied by multiple short video files, thereby saving the storage space of the recording device.

In an exemplary embodiment, as shown in FIG. 18, splicing the paused video and the continuation video to generate the target video includes the following steps.

S1801: determining a third splicing position of the paused video.

In some embodiments, the third splicing position is the position in the paused video where the continuation video is spliced.

The third splicing position can also be manually selected by the user in the paused video and sent to the computer device of the recording device, or the paused video can be input into a pre-trained video selection model, and the video selection model analyzes the paused video to output the third splicing position.

In some embodiments, as shown in FIG. 19, determining the third splicing position of the paused video includes the following steps.

S1901: verifying each frame of the paused video.

After the computer device of the recording device obtains the paused video, it can verify the quality of each frame of the paused video to determine whether the paused video meets the requirements. For example, the resolution of each frame of the paused video can be verified, and it can also be determined whether there is a blurred image in each frame of the video, etc. If there is a blurred image in the video frame, it is determined that the video frame does not pass the verification, and if there is no blurred image in the video frame, it is determined that the video frame passes the verification.

S1902: determining the third splicing position based on the verification result of each frame of the video.

In some embodiments, the third splicing position can be the splicing position of the paused video with the continuation video.

If all video frames of the paused video pass the verification, it indicates that the quality of all video frames in the paused video meets the conditions, and the last frame of the paused video can be used as the third splicing position.

If a certain video frame in the paused video does not pass the verification, it indicates that the quality of the video frame does not meet the conditions, and the video frame can be removed, and the frame before the video frame that does not pass the verification in the paused video can be used as the third splicing position. In some embodiments, if there are multiple video frames in the paused video that do not pass the verification, the frame before the earliest video frame collected in the video frames that do not pass the verification can be used as the third splicing position. For example, if the video frames that do not pass the verification in the paused video are the 5th frame, the 7th frame, and the 10th frame, then the 4th frame before the 5th frame can be used as the third splicing position.

The method for continuing video recording provided by some embodiments of the present disclosure includes: verifying each frame of the paused video; and determining the third splicing position based on the verification result of each frame of the video. In this method, by verifying each frame of the paused video, and based on the verification result of the video frame, the third splicing position can be accurately determined from the paused video.

S1802: determining a fourth splicing position of the continuation video.

In some embodiments, the fourth splicing position can be the splicing position of the continuation video with the paused video.

Each frame of the continuation video can also be verified, and the second splicing video frame can be determined based on the verification result of each frame of the continuation video. Specifically, the quality of each frame of the continuation video can be verified to determine whether the paused video meets the requirements. For example, the resolution of each frame of the continuation video can be verified, and it can also be determined whether there is a blurred image in each frame of the video, etc. If there is a blurred image in the video frame, it is determined that the video frame does not pass the verification, and if there is no blurred image in the video frame, it is determined that the video frame passes the verification.

If all video frames of the continuation video pass the verification, the first frame of the continuation video can be used as the fourth splicing position; and if there are video frames in the continuation video that do not pass the verification, the frame after the latest video frame collected in the video frames that do not pass the verification can be used as the fourth splicing position. For example, if the video frames that do not pass the verification in the continuation video are the 5th frame, the 7th frame, and the 10th frame, then the 11th frame after the 10th frame can be used as the fourth splicing position.

In some embodiments, the fourth splicing position can also be manually selected by the user in the continuation video and sent to the computer device of the recording device, or the continuation video can be input into a pre-trained video selection model, and the video selection model analyzes the paused video to output the fourth splicing position.

S1803: splicing the fourth splicing position of the continuation video with the third splicing position of the paused video, until the recording of the continuation video ends, to obtain the target video.

Splice the continuation video from the fourth splicing position of the continuation video with the paused video at the third splicing position, until the recording of the continuation video ends, to obtain the target video. The target video can include at least one video segment in the paused video and the continuation video, and the target video includes the video frames in the paused video before the third splicing position, and the video frames in the continuation video after the fourth splicing position.

In some embodiments, the paused video and the continuation video can be spliced through the third splicing position and the fourth splicing position to obtain the target video.

The method for continuing video recording provided by some embodiments of the present disclosure includes determining the third splicing position of the paused video, and determining the fourth splicing position of the continuation video, and then splicing the fourth splicing position of the continuation video with the third splicing position of the paused video, until the recording of the continuation video ends, to obtain the target video. In this method, the third splicing video frame of the paused video and the second video frame of the continuation video are spliced together to obtain the target video, making the obtained target video more effective and accurate.

In one embodiment, when the user performs a first operation on a recording element of the interactive device, the recording device is controlled to pause recording; when the user performs a first operation on a recording element of the interactive device, the power consumption working mode of the recording device is controlled to switch to a low power consumption mode, and when the user performs a recovery operation on a recording element of the interactive device, the power consumption working mode of the recording device is controlled to exit the low power consumption mode. In some embodiments, the recovery operation can indicate controlling the recording device to adjust from a paused recording state to a continued recording state, or the recovery operation can also indicate controlling the recording device to adjust from a non-recording state to a recording state.

In some embodiments, the power consumption working mode of the recording device includes a low power consumption mode and a high power consumption mode. The recording device is in a high power consumption mode during recording, and in a low power consumption mode during paused recording or stopped recording.

In this embodiment, when the recording device is in a recording state, its power consumption is high, and the power consumption working mode is a high power consumption mode. After receiving the first operation performed by the user on the interactive device, the recording device is in a paused state. At this time, the recording device does not need to record, and the computer device can control the power consumption working model of the recording device to switch from a high power consumption mode to a low power consumption mode. Subsequently, after receiving the recovery operation performed by the user on the recording element of the interactive device of the recording device, the recording device resumes the recording state, and the computer device then controls the power consumption working mode of the recording device to switch from a low power consumption mode to a high power consumption mode.

In some embodiments of the present disclosure, based on the first operation and the recovery operation, the power consumption working mode of the recording device is switched, so that the recording device is in a low power consumption mode when it is paused, which can greatly reduce the power consumption during the use of the recording device.

In an exemplary embodiment, the video collection progress at the time of the first operation can be stored in the storage unit, the encoding of the video frame in the storage unit can be stopped, and the encoding clock can be switched to the off state. When the encoding clock is in the off state, the power consumption working mode of the recording device is switched to the low power consumption mode.

In some embodiments, the video collection progress indicates the collection time period during the video collection process.

In this embodiment, after receiving the first operation performed by the user, the computer device can obtain the video collection progress at the time of the first operation and store the video collection progress. Subsequently, after the encoding of the video frame at the time of the first operation in the storage unit is completed, the encoding is stopped, and the encoding clock is turned off.

In this embodiment, when the encoding clock is turned off, the recording device is completely in a non-working state, and at this time, the power consumption working mode of the recording device is switched to the low power consumption mode.

In some embodiments of the present disclosure, the video collection progress at the time of the first operation is stored in the storage unit, and the encoding of the video frame in the storage unit is stopped, and the encoding clock is switched to the off state. When the encoding clock is in the off state, the power consumption working mode of the recording device is switched to the low power consumption mode. This method stops the encoding process and switches the recording device to the low power consumption mode after receiving the pause instruction by sequentially turning off the encoding and the encoding clock.

Based on the above embodiments, this embodiment introduces the relevant content after the recording device exits the low power consumption mode. This embodiment includes: switching the encoding clock from the off state to the on state, and when the encoding clock is in the on state, the recording device is in a recording state.

In this embodiment, after the recording device exits the low power consumption mode, the recording device needs to resume recording, and the computer device can switch the encoding clock inside the recording device from the off state to the on state.

When the encoding clock is on, the recording device continues to record, and the video frame in the storage unit can continue to be encoded.

In some embodiments of the present disclosure, switch the encoding clock from the off state to the on state; and when the encoding clock is in the on state, the recording device is in a recording state. This method restarts the encoding clock after exiting the low power consumption mode, and at this time, the recording device can continue to start recording.

Based on the above embodiments, this embodiment introduces the relevant content of the recording device pausing recording. This embodiment includes: in response to the first operation performed by the user, outputting a reminder message through the display device; the reminder message is used to indicate that the recording device is in a paused recording state; and in response to the recovery operation performed by the user, stopping the output of the reminder message through the display device.

In this embodiment, after the user performs the first operation on the recording element of the interactive device, the computer device outputs a reminder message through the display device to remind the user that the recording device is currently in a paused recording state. In some embodiments, the display device includes a recording pause indicator light, a display screen, or a voice reminder, etc. For example, when the recording device is in a paused state, the pause indicator light is on, or the text information of the paused state is displayed on the display screen, or the voice reminder message is output by the voice device on the recording device.

After the user performs the recovery operation on the recording element of the interactive device, the computer device can control the display device to stop outputting the reminder message. For example, when the recording device resumes recording, the pause indicator light goes out, or the text information of the paused state is not displayed on the display screen, or the voice device on the recording device is turned off.

In some embodiments of the present disclosure, when the recording device is in a paused state, the display device reminds that the recording device is in a paused recording state to remind the user, improving the convenience of the recording device during the movement process.

Based on the above embodiments, this embodiment introduces the relevant content of the recording device pausing recording. As a non-limiting example, this embodiment includes: when the recording device is in a paused recording state, and no recovery operation triggered by the user on the recording device is received within a preset time period, switching the recording device to a shutdown state.

In this embodiment, to save the power consumption of the recording device, when the recording device is in a paused recording state, and no recovery operation triggered by the user is received within a preset time period, the recording device automatically enters the shutdown state, and at this time, the power consumption of the recording device is zero.

In some embodiments of the present disclosure, when the recording device is in a paused recording state, and no recovery operation triggered by the user on the recording device is received within a preset time period, switching the recording device to a shutdown state. This method switches the recording device to the shutdown state when the recording device is paused and has not resumed recording for a long time, which can save the power consumption of the recording device and also improve the operational convenience of the recording device.

Based on the above embodiments, this embodiment introduces the relevant content about the recording device’s shutdown and restart. As a non-limiting example, this embodiment includes: when the recording device is in a shutdown and restart state, determining whether the state of the recording device at the shutdown time is a paused recording state or a recording state; and if so, displaying the paused video frame at the shutdown time on the recording device.

In this embodiment, when the recording device is in a shutdown and restart state, the shutdown situation includes shutdown caused by long-term non-resumption of recording after pausing, shutdown caused by low battery of the recording device, etc. After restarting, the computer device can obtain the state of the recording device at the shutdown time, and the state includes a paused recording state, a recording state, and a stopped recording state, and it can be determined whether the recording device was in a paused state or a recording state at the shutdown time.

When it is determined that the recording device was in a paused state or a recording state at the shutdown time, after the recording device restarts, the paused video frame at the shutdown time is displayed on the recording device. The user can determine whether to resume recording or end recording based on the paused video frame at the shutdown time.

In some embodiments of the present disclosure, when the recording device is in a shutdown and restart state, determining whether the state of the recording device at the shutdown time is a paused recording state or a recording state; and if so, displaying the paused video frame at the shutdown time on the recording device. This method displays the paused video frame at the shutdown time on the recording device after the recording device restarts, which facilitates the continuation of the recording process of the recording device, and its convenience is higher.

In one embodiment, a method for continuing video recording is provided, in which the recording device is in a recording state, and in response to a pause instruction triggered by the user on the recording device, recording is stopped, the power consumption working mode of the recording device is controlled to be in a low power consumption mode, and the paused recording state of the recording device is displayed through the display device of the recording device. If a continue recording instruction triggered by the user is received within a preset duration, exit the low power consumption mode and continuing recording; and if not, save the video collection progress of the paused state and control the recording device to switch to the shutdown state.

The process of the recording device entering the low power consumption mode includes: after receiving the pause instruction triggered by the user, storing the video collection progress at the time of the pause instruction trigger to the storage unit; stopping the encoding of the video frame in the storage unit, and switching the encoding clock to the off state; and when the encoding clock is in the off state, the power consumption working mode of the recording device is switched to the low power consumption mode.

The process of the recording device exiting the low power consumption mode includes: reading the video collection progress of the recording device at the time of the pause instruction trigger, and controlling the power consumption working mode of the recording device to exit the low power consumption mode; switching the encoding clock from the off state to the on state; and when the encoding clock is in the on state, the recording device is in a recording state.

The process after the recording device restarts includes: when the recording device is in a shutdown and restart state, obtaining the state of the recording device at the shutdown time; determining whether the state of the recording device at the shutdown time is a paused recording state or a recording state; if a resume recording instruction triggered by the user is received, continuing recording based on the resume recording instruction; and if not, ending recording.

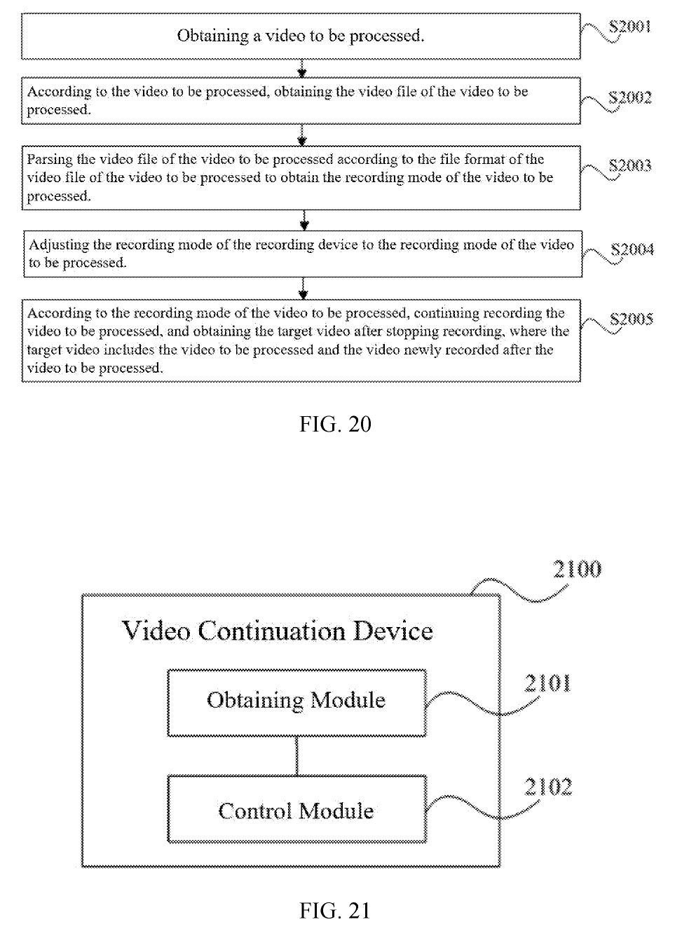

In one embodiment, some embodiments of the present disclosure also provide a method for continuing video recording, taking the computer device in the recording device as the execution subject as an example for explanation, as shown in FIG. 20, this embodiment includes the following steps.

S2001: obtaining a video to be processed.

In some embodiments, the video to be processed can be a recorded video selected by the user on the video playback page of the recording device or a paused video obtained after the current pause recording of the recording device.

S2002: obtaining a video file of the video to be processed according to the video to be processed.

S2003: parsing the video file of the video to be processed according to the file parsing method corresponding to the file format of the video file of the video to be processed to obtain the recording mode of the video to be processed.

In some embodiments, the recording mode includes the recording parameter corresponding to the video to be processed.

S2004: adjusting the recording mode of the recording device to the recording mode of the video to be processed.

S2005: continuing recording the video to be processed according to the recording mode of the video to be processed, and obtaining the target video after stopping recording; the target video includes the video to be processed and the newly recorded video after the video to be processed.

It should be noted that when continuing recording the video to be processed, the computer device can control the camera in the recording device to continue recording from any time point of the video to be processed as the start time of continuation recording.

In some embodiments, after stopping recording, the audio file and image file, etc., of the complete video are written into the continuation file, and the recording device will automatically enter the playback page to display the complete video that has just been recorded.

In the method for continuing video recording provided by some embodiments of the present disclosure, the video can be quickly continued, and it can quickly record the movement process of the subject being recorded, ensuring that every exciting moment of the subject being recorded can be perfectly captured. Moreover, this method can simplify the operation, and through an easy-to-use interface and software processing process, users can easily continue recording any video on the playback page of the recording device without complicated post-processing, which greatly reduces the complexity of user operations, allowing users to focus more on the movement itself. In the continuation recording state, the recording mode of the recording device is the same as the recording mode of the video to be processed, ensuring that the image quality and sound effect of the continuation video and the video to be processed are consistent, improving the coherence of the video. Furthermore, users can enable the continuation recording function at any time point, avoiding the time-consuming process of creating new videos through multiple recordings, making the recorded video more continuous, avoiding missing important scenes, and avoiding generating multiple short videos, synthesizing multiple short videos into one large video during the video continuation process of the recording device, saving the storage space of the recording device.

It should be understood that although the steps in the flowcharts of the various embodiments described above are shown sequentially according to the arrows, these steps are not necessarily executed in the order indicated by the arrows. Unless explicitly stated herein, there is no strict sequence limitation on the execution of these steps, and these steps can be executed in other orders. Moreover, at least some of the steps in the flowcharts of the various embodiments described above may include multiple steps or multiple stages, and these steps or stages do not necessarily have to be completed at the same time, but can be executed at different times, and the execution order of these steps or stages is not necessarily sequential, but can be executed alternately or in rotation with at least some of the steps or stages in other steps or other steps.

Based on the same inventive concept, some embodiments of the present disclosure also provide a recording device, which includes: a camera, a display, a processor, a memory, and an interactive device: the camera is configured to capture images; the display is connected to the processor; the memory stores a computer program including instructions; and when the instructions are executed by the processor, the processor is configured to:

obtain a video to be processed, which includes a recorded video or a paused video that the camera of the recording device has currently paused recording, and the recording device is configured to pause recording during a recording process;

in response to a user operation of the interactive device, control the camera of the recording device to record a continuation video; and

when the video to be processed is the recorded video, generate a target video according to the recorded video and the continuation video; or

when the video to be processed is the paused video that the recording device has currently paused recording, generate a target video according to the paused video and the continuation video.

In one embodiment, the processor is further configured to:

control the display to display at least one pre-stored video on an album page of the recording device;

in response to the user operation of the interactive device, determine a candidate video selected by the user from the at least one pre-stored video; and

determine the candidate video as the recorded video.

In one embodiment, the processor is further configured to:

obtain a reference video selected by the user from the pre-stored video;

based on the user operation of the interactive device, obtain a to-be-cut segment selected by the user from the reference video; and

delete the to-be-cut segment from the reference video to obtain a trimmed video, and determine the candidate video according to the trimmed video.

In one embodiment, the processor is further configured to:

in a case where the user performs a trim activation operation on the interactive device, control the display to display a display element corresponding to the reference video; and

based on a segment selection operation of the user on the display element, determine the to-be-cut segment.

In one embodiment, the processor is further configured to:

obtain a first video segment before the start time from the reference video according to the start time of the to-be-cut segment;

obtain a second video segment after the end time from the reference video according to the end time of the to-be-cut segment; and

splice the first video segment and the second video segment to obtain the trimmed video.

In one embodiment, the processor is further configured to:

when the camera of the recording device is in a recording state, obtain a user operation of the interactive device; and

based on the user operation of the interactive device, determine the paused video that the recording device has currently paused recording.

In one embodiment, the processor is further configured to:

in a case where the user performs a first operation on a recording element of the interactive device, control the camera of the recording device to pause recording to obtain a paused segment; and

determine the paused video that the recording device has currently paused recording according to the paused segment.

In one embodiment, the processor is further configured to:

based on a second operation of the user on the interactive device, obtain a to-be-cut segment selected by the user from the paused segment;

delete the to-be-cut segment from the paused segment to obtain a trimmed video; and

determine the paused video that the recording device has currently paused recording according to the trimmed video.

In one embodiment, the processor is further configured to:

in a case where the user performs a trim activation operation on the interactive device, control the display to display a display element corresponding to the paused segment; and

based on a segment selection operation of the user on the display element, determine the to-be-cut segment.

In one embodiment, the processor is further configured to:

obtain a third video segment before the start time from the paused segment according to the start time of the to-be-cut segment;

obtain a fourth video segment after the end time from the paused segment according to the end time of the to-be-cut segment; and

splice the third video segment and the fourth video segment to obtain the trimmed video.

In one embodiment, the processor is further configured to:

in response to the user operation of the interactive device, obtain a recording parameter based on at least one video parameter of the video to be processed; and

control the camera of the recording device to record a video according to the recording parameter to obtain the continuation video.

In one embodiment, the processor is further configured to:

obtain a video file of the video to be processed, where the video file includes file information of the video to be processed;

parse the file information according to a preset file parsing method to obtain at least one video parameter of the video to be processed; and

determine the recording parameter according to the at least one video parameter.

In one embodiment, the processor is further configured to:

detect whether a condition for stopping recording is met; and

if the condition for stopping recording is met, control the camera of the recording device to stop recording to obtain the continuation video.

In one embodiment, the condition for stopping recording includes at least one of the following:

receiving a stop recording instruction input by a user;

a duration of the current continuation recording reaches a preset recording duration; and

a current memory space reaches a preset memory space occupation threshold.

In one embodiment, the processor is further configured to:

in response to a user operation of the interactive device, confirm an insertion position of the continuation video in the recorded video; and

insert the continuation video into the insertion position.

In one embodiment, the processor is further configured to:

delete a target segment after the insertion position in the recorded video.

In one embodiment, the processor is further configured to:

splice the recorded video and the continuation video to generate the target video.

In one embodiment, the processor is further configured to:

determine a first splicing position of the recorded video;

determine a second splicing position of the continuation video; and

splice the second splicing position of the continuation video with the first splicing position of the recorded video, until the recording of the continuation video ends, to obtain the target video.

In one embodiment, the processor is further configured to:

verify each frame of the recorded video; and

determine the first splicing position based on a verification result of each frame of the recorded video.

In one embodiment, the processor is further configured to:

in response to a user operation of the interactive device, confirm an insertion position of the continuation video in the paused video; and

insert the continuation video into the insertion position.

In one embodiment, the processor is further configured to:

delete a target segment after the insertion position in the paused video.

In one embodiment, the processor is further configured to:

splice the paused video and the continuation video to generate the target video.

In one embodiment, the processor is further configured to:

determine a third splicing position of the paused video;

determine a fourth splicing position of the continuation video; and

splice the fourth splicing position of the continuation video with the third splicing position of the paused video, until the recording of the continuation video ends, to obtain the target video.

In one embodiment, the processor is further configured to:

verify each frame of the paused video; and

determine the third splicing position based on a verification result of each frame of the paused video.

The steps implemented when the instructions are executed by the processor in this embodiment have similar implementation principles and technical effects to the principles of the method for continuing video recording described above, and will not be repeated here.

Based on the same inventive concept, some embodiments of the present disclosure also provide a video continuation device for implementing the method for continuing video recording described above. The solution provided by this device for solving the problem is similar to the implementation solution described in the method above, so the specific limitations in one or more embodiments of the video continuation device provided below can be referred to the limitations of the method for continuing video recording described above, and will not be repeated here.

In one embodiment, as shown in FIG. 21, a video continuation device 2100 is provided, including: an obtaining module 2101 and a control module 2102, where:

the obtaining module 2101 is configured to obtain a video to be processed, which includes a recorded video or a paused video that the recording device has currently paused recording, and the recording device has a function of pausing recording during a recording process; and

the control module 2102 is configured to, in response to a user operation of the interactive device, control the recording device to record a continuation video, and when the video to be processed is the recorded video, generate a target video according to the recorded video and the continuation video; or when the video to be processed is the paused video that the recording device has currently paused recording, generate a target video according to the paused video and the continuation video.

In one embodiment, the obtaining module 2101 includes:

a display unit, configured to display at least one pre-stored video on an album page of the recording device; and

a first determining unit, configured to, in response to a user operation of the interactive device, determine a candidate video selected by the user from the at least one pre-stored video and determine the candidate video as the recorded video.

In one embodiment, the first determining unit can be configured to: obtain a reference video selected by the user from the pre-stored video; based on the user operation of the interactive device, obtain a to-be-cut segment selected by the user from the reference video; and delete the to-be-cut segment from the reference video to obtain a trimmed video, and determine the candidate video according to the trimmed video.

In one embodiment, the first determining unit is further configured to: in a case where the user performs a trim activation operation on the interactive device, display a display element corresponding to the reference video; and based on a segment selection operation of the user on the display element, determine the to-be-cut segment.

In one embodiment, the first determining unit is further configured to: obtain a first video segment before the start time from the reference video according to the start time of the to-be-cut segment; obtain a second video segment after the end time from the reference video according to the end time of the to-be-cut segment; and splice the first video segment and the second video segment to obtain the trimmed video.

In one embodiment, the obtaining module 2101 includes:

a first obtaining unit, configured to, when the recording device is in a recording state, obtain a user operation of the interactive device; and

a second determining unit, configured to, based on the user operation of the interactive device, determine the paused video that the recording device has currently paused recording.

In one embodiment, the second determining unit can be configured to: in a case where the user performs a first operation on a recording element of the interactive device, control the recording device to pause recording to obtain a paused segment; and determine the paused video that the recording device has currently paused recording according to the paused segment.

In one embodiment, the second determining unit is further configured to: based on a second operation of the user on the interactive device, obtain a to-be-cut segment selected by the user from the paused segment; delete the to-be-cut segment from the paused segment to obtain a trimmed video; and determine the paused video that the recording device has currently paused recording according to the trimmed video.

In one embodiment, the second determining unit is further configured to: in a case where the user performs a trim activation operation on the interactive device, display a display element corresponding to the paused segment; and based on a segment selection operation of the user on the display element, determine the to-be-cut segment.

In one embodiment, the second determining unit is further configured to: obtain a third video segment before the start time from the paused segment according to the start time of the to-be-cut segment; obtain a fourth video segment after the end time from the paused segment according to the end time of the to-be-cut segment; and splice the third video segment and the fourth video segment to obtain the trimmed video.

In one embodiment, the control module 2102 includes:

a second obtaining unit, configured to, in response to the user operation of the interactive device, obtain a recording parameter based on at least one video parameter of the video to be processed; and

an obtaining unit, configured to control the recording device to record a video according to the recording parameter to obtain the continuation video.

In one embodiment, the second obtaining unit can be configured to: obtain a video file of the video to be processed, where the video file includes file information of the video to be processed; parse the file information according to a preset file parsing method to obtain at least one video parameter of the video to be processed; and determine the recording parameter according to the at least one video parameter.

In one embodiment, the obtaining unit can be configured to detect whether a condition for stopping recording is met; and if the condition for stopping recording is met, control the recording device to stop recording to obtain the continuation video.

In one embodiment, the condition for stopping recording includes at least one of the following: a stop recording instruction input by a user is received; a duration of the current continuation recording reaches a preset recording duration; or a current memory space reaches a preset memory space occupation threshold.

In one embodiment, the control module 2102 includes:

a first confirming unit, configured to, in response to a user operation of the interactive device, confirm an insertion position of the continuation video in the recorded video; and

a first inserting unit, configured to insert the continuation video into the insertion position.

In one embodiment, the device 2100 further includes:

a first deleting module, configured to delete a target segment after the insertion position in the recorded video.

In one embodiment, the control module 2102 includes:

a first splicing unit, configured to splice the recorded video and the continuation video to generate the target video.

In one embodiment, the first splicing unit can be configured to: determine a first splicing position of the recorded video; determine a second splicing position of the continuation video; and splice the second splicing position of the continuation video with the first splicing position of the recorded video, until the recording of the continuation video ends, to obtain the target video.

In one embodiment, the first splicing unit is further configured to: verify each frame of the recorded video; and determine the first splicing position based on a verification result of each frame of the recorded video.

In one embodiment, the control module 2102 includes:

a second confirming unit, configured to, in response to a user operation of the interactive device, confirm an insertion position of the continuation video in the paused video; and

a second inserting unit, configured to insert the continuation video into the insertion position.

In one embodiment, the device 2100 further includes:

a second deleting module, configured to delete a target segment after the insertion position in the paused video.

In one embodiment, the control module 2102 includes:

a second splicing unit, configured to splice the paused video and the continuation video to generate the target video.

In one embodiment, the second splicing unit can be configured to: determine a third splicing position of the paused video; determine a fourth splicing position of the continuation video; and splice the fourth splicing position of the continuation video with the third splicing position of the paused video, until the recording of the continuation video ends, to obtain the target video.

In one embodiment, the second splicing unit is further configured to: verify each frame of the paused video; and determine the third splicing position based on a verification result of each frame of the paused video.

The various modules in the video continuation device described above can be implemented entirely or partially through software, hardware, or a combination thereof. The above modules can be embedded in or independent of the processor in the computer device in hardware form, or stored in the memory in the computer device in software form, so that the processor can call and execute the operations corresponding to the above modules.

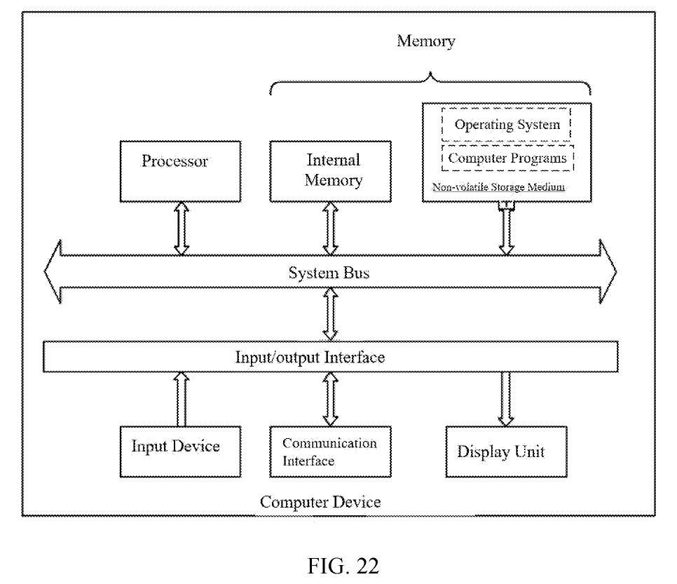

In an exemplary embodiment, a computer device is provided, which can be a terminal, and its internal structure diagram can be as shown in FIG. 22. The computer device includes a processor, a memory, an input/output interface, a communication interface, a display unit, and an input device. In some embodiments, the processor, memory, and input/output interface are connected through a system bus, and the communication interface is connected to the system bus through the input/output interface. In some embodiments, the processor of the computer device is configured to provide computing and control capabilities. The memory of the computer device includes non-volatile storage media and internal memory. The non-volatile storage media stores the operating system and computer programs. The internal memory provides an environment for the operation of the operating system and computer programs in the non-volatile storage media. The input/output interface of the computer device is used for exchanging information between the processor and external devices. The communication interface of the computer device is used for wired or wireless communication with external terminals, and wireless communication can be realized through WIFI, mobile cellular networks, NFC (Near Field Communication), or other technologies. The computer program is executed by the processor to implement a method for continuing video recording.

Those skilled in the art can understand that the structure shown in FIG. 22 is merely a block diagram of part of the structure related to the solution of the present disclosure and does not constitute a limitation on the computer device to which the present disclosure is applied. The specific computer device may include more or fewer components than shown in the figure, or combine certain components, or have different component arrangements.

In one embodiment, a computer device is also provided, including a memory and a processor, where the memory stores a computer program, and the processor implements the steps in the above method embodiments when executing the computer program.

The steps implemented by the processor in this embodiment have similar implementation principles and technical effects to the principles of the method for continuing video recording described above, and will not be repeated here.

In one embodiment, a computer-readable storage medium is provided, on which a computer program is stored, and the computer program implements the steps in the above method embodiments when executed by the processor.

The steps implemented by the computer program when executed by the processor in this embodiment have similar implementation principles and technical effects to the principles of the method for continuing video recording described above, and will not be repeated here.

In one embodiment, a computer program product is provided, including a computer program, and the computer program implements the steps in the above method embodiments when executed by the processor.

The steps implemented by the computer program when executed by the processor in this embodiment have similar implementation principles and technical effects to the principles of the method for continuing video recording described above, and will not be repeated here.

It should be noted that the data involved in the present disclosure (including but not limited to data used for analysis, storage, display, etc.) are all information and data authorized by the user or fully authorized by all parties, and the collection, use, and processing of related data need to comply with relevant laws, regulations, and standards of relevant countries and regions.

Those skilled in the art can understand that all or part of the processes in the above method embodiments can be completed by instructing related hardware through a computer program, and the computer program can be stored in a non-volatile computer-readable storage medium. When the computer program is executed, it can include the processes of the method embodiments described above. Where, any reference to memory, database, or other media used in some embodiments provided by the present disclosure can include at least one non-volatile and volatile memory. Non-volatile memory can include Read-Only Memory (ROM), magnetic tape, floppy disk, flash memory, optical storage, high-density embedded non-volatile memory, resistive memory (ReRAM), Magnetoresistive random access memory (MRAM), ferroelectric random access memory (FRAM), phase change memory (PCM), graphene memory, etc. Volatile memory can include Random Access Memory (RAM) or external cache memory, etc. As an illustration and not limitation, RAM can be in various forms, such as Static Random Access Memory (SRAM) or Dynamic Random Access Memory (DRAM), etc. The database involved in some embodiments provided by the present disclosure can include at least one of relational databases and non-relational databases. Non-relational databases can include blockchain-based distributed databases, etc., but are not limited to this. The processor involved in some embodiments provided by the present disclosure can be a general processor, central processor, graphics processor, digital signal processor, programmable logic device, quantum computing-based data processing logic device, etc., but is not limited to this.

The technical features of the above embodiments can be combined arbitrarily. For the sake of brevity, not all possible combinations of the technical features in the above embodiments are described, but as long as there is no contradiction in these combinations, they should be considered within the scope of this specification.

The above embodiments only express several implementation modes of the present disclosure, and their descriptions are relatively specific and detailed, but they should not be understood as limitations on the scope of the present disclosure. It should be noted that for those skilled in the art, several modifications and improvements can be made without departing from the concept of the present disclosure, and these all belong to the protection scope of the present disclosure. Therefore, the protection scope of the present disclosure should be subject to the claims appended.

What is claimed is:

1. A method for continuing video recording, applied to a recording device, wherein the recording device comprises an interactive device, and the method comprises:
obtaining a video to be processed, wherein the video to be processed comprises a recorded video or a paused video that the recording device has currently paused recording, and the recording device is configured to pause recording during a recording process;
in response to a user operation of the interactive device, controlling the recording device to record a continuation video;
in response to determining that the video to be processed is the recorded video, generating a target video according to the recorded video and the continuation video; and
in response to determining that the video to be processed is the paused video that the recording device has currently paused recording, generating a target video according to the paused video and the continuation video.

2. The method according to claim 1, wherein obtaining the recorded video comprises:
displaying at least one pre-stored video on an album page of the recording device;
in response to the user operation of the interactive device, determining a candidate video selected by a user from the at least one pre-stored video; and
determining the candidate video as the recorded video.

3. The method according to claim 2, wherein in response to the user operation of the interactive device, determining the candidate video selected by the user from the at least one pre-stored video comprises:
obtaining a reference video selected by the user from the at least one pre-stored video;
based on the user operation of the interactive device, obtaining a to-be-cut segment selected by the user from the reference video; and
deleting the to-be-cut segment from the reference video to obtain a trimmed video, and determining the candidate video according to the trimmed video.

4. The method according to claim 3, wherein based on the user operation of the interactive device, obtaining the to-be-cut segment selected by the user from the reference video comprises:
in response to determining that the user performs a trim activation operation on the interactive device, displaying a display element corresponding to the reference video; and
based on a segment selection operation of the user on the display element, determining the to-be-cut segment.

5. The method according to claim 3, wherein deleting the to-be-cut segment from the reference video to obtain the trimmed video comprises:
according to start time of the to-be-cut segment, obtaining a first video segment before the start time from the reference video;
according to end time of the to-be-cut segment, obtaining a second video segment after the end time from the reference video; and
splicing the first video segment and the second video segment to obtain the trimmed video.

6. The method according to claim 1, wherein obtaining the paused video that the recording device has currently paused recording comprises:
in response to determining that the recording device is in a recording state, obtaining the user operation of the interactive device; and
based on the user operation of the interactive device, determining the paused video that the recording device has currently paused recording.

7. The method according to claim 1, wherein in response to the user operation of the interactive device, controlling the recording device to record the continuation video comprises:
in response to the user operation of the interactive device, obtaining a recording parameter based on at least one video parameter of the video to be processed; and
controlling the recording device to record a video according to the recording parameter to obtain the continuation video.

8. The method according to claim 1, wherein generating the target video according to the recorded video and the continuation video comprises:
in response to the user operation of the interactive device, confirming an insertion position of the continuation video in the recorded video; and
inserting the continuation video into the insertion position.

9. The method according to claim 1, wherein generating the target video according to the recorded video and the continuation video comprises:
splicing the recorded video and the continuation video to generate the target video.

10. The method according to claim 1, wherein generating the target video according to the paused video and the continuation video comprises:
in response to the user operation of the interactive device, confirming an insertion position of the continuation video in the paused video; and
inserting the continuation video into the insertion position.

11. The method according to claim 1, wherein generating the target video according to the paused video and the continuation video comprises:
splicing the paused video and the continuation video to generate the target video.

12. A recording device, comprising a camera, a processor, a memory, and an interactive device, wherein the camera is configured to capture an image, the interactive device is connected to the processor, and the memory stores a computer program comprising instructions, when the instructions are executed by the processor, the processor being configured to:
obtain a video to be processed, wherein the video to be processed comprises a recorded video or a paused video that the camera of the recording device has currently paused recording, and the recording device is configured to pause recording during a recording process;
in response to a user operation of the interactive device, control the camera of the recording device to record a continuation video;
in response to determining that the video to be processed is the recorded video, generate a target video according to the recorded video and the continuation video; or
in response to determining that the video to be processed is the paused video that the recording device has currently paused recording, generate a target video according to the paused video and the continuation video.

13. The recording device according to claim 12, wherein the processor is further configured to:
display at least one pre-stored video on an album page of the recording device;
in response to the user operation of the interactive device, determine a candidate video selected by a user from the at least one pre-stored video; and
determine the candidate video as the recorded video.

14. The recording device according to claim 13, wherein the processor is further configured to:
obtain a reference video selected by the user from the at least one pre-stored video;
based on the user operation of the interactive device, obtain a to-be-cut segment selected by the user from the reference video; and
delete the to-be-cut segment from the reference video to obtain a trimmed video, and determine the candidate video according to the trimmed video.

15. The recording device according to claim 14, wherein the processor is further configured to:
in response to determining that the user performs a trim activation operation on the interactive device, display a display element corresponding to the reference video; and
based on a segment selection operation of the user on the display element, determine the to-be-cut segment.

16. The recording device according to claim 14, wherein the processor is further configured to:
according to start time of the to-be-cut segment, obtain a first video segment before the start time from the reference video;
according to end time of the to-be-cut segment, obtain a second video segment after the end time from the reference video; and
splice the first video segment and the second video segment to obtain the trimmed video.

17. The recording device according to claim 12, wherein the processor is further configured to:
in response to determining that the camera of the recording device is in a recording state, obtain the user operation of the interactive device; and
based on the user operation of the interactive device, determine the paused video that the recording device has currently paused recording.

18. The recording device according to claim 12, wherein the processor is further configured to:
in response to the user operation of the interactive device, obtain a recording parameter based on at least one video parameter of the video to be processed; and
control the camera of the recording device to record a video according to the recording parameter to obtain the continuation video.

19. The recording device according to claim 12, wherein the processor is further configured to:
in response to the user operation of the interactive device, confirm an insertion position of the continuation video in the recorded video; and
insert the continuation video into the insertion position.

20. The recording device according to claim 12, wherein the processor is further configured to:
splice the recorded video and the continuation video to generate the target video.
